(19) United States
(12) Patent Application Publication
(10) Pub. No.: US 2011/0033735 A1
(43) Pub. Date: Feb. 10, 2011

(54) BATTERY PACK

(76) Inventors: Masahiro Kinoshita, Osaka (JP); Masaya Ugaji, Osaka (JP); Taisuke Yamamoto, Nara (JP); Tatsuki Hiraoka, Osaka (JP)

Correspondence Address: MCDERMOTT WILL & EMERY LLP, 600 13TH STREET, NW, WASHINGTON, DC, 20005-3096, US

(21) Appl. No.: 12/936,353

(22) PCT Filed: Nov. 27, 2009
(86) PCT No.: PCT/JP2009/006417

§ 371 Date: Oct. 4, 2010

(30) Foreign Application Priority Data
Dec. 5, 2008 (JP) 2008-310919
Sep. 18, 2009 (JP) 2009-216576

(51) Int. Cl. H01M 10/48

(52) U.S. Cl. 429/90

(57) ABSTRACT

A battery pack 1 includes a battery 10, thickness detection means 11, cycle number detection means 12, and first determination means 13. The battery 10 is an alloy-type secondary battery having an electrode assembly 20 which includes a positive electrode, a negative electrode including an alloyable active material, and an insulating layer. The thickness detection means 11 detects the thickness of the electrode assembly 20 of the battery 10. The cycle number detection means 12 detects the number of charge and discharge cycles of the battery 10. The first determination means 13 determines the replacement time of the battery 10 according to the detection results by the thickness detection means 11 and the cycle number detection means 12. This configuration allows the battery pack including the alloy-type secondary battery to estimate the replacement time of the alloy-type secondary battery almost accurately, thereby enhancing the convenience of the battery pack.

### TECHNICAL FIELD

The invention relates to a battery pack. More specifically, the invention relates to an improvement in a method for determining the replacement time of a non-aqueous electrolyte secondary battery using an alloyable active material as a negative electrode active material and a method for determining cycle deterioration thereof.

### BACKGROUND ART

Non-aqueous electrolyte secondary batteries are widely used as the power source for electronic devices, since they have high capacity and high energy density and can be easily made compact and light-weight. Examples of electronic devices include cellular phones, personal digital assistants, computers, video cameras, game machines and the like. Also, the use of non-aqueous electrolyte secondary batteries as the power source for electric vehicles is actively investigated, and some are being put to practical use in such application. A representative non-aqueous electrolyte secondary battery includes a positive electrode including a lithium cobalt composite oxide, a negative electrode including graphite, and a porous film made of polyolefin.

Alloyable active materials are known as negative electrode active materials in addition to carbon materials. Representative alloyable active materials include silicon-based active materials such as silicon and silicon oxides. Alloyable active materials have high discharge capacities. The theoretical discharge capacity of silicon is approximately 11 times that of graphite. Therefore, the use of an alloyable active material allows a non-aqueous electrolyte secondary battery to have a high capacity and high performance.

A non-aqueous electrolyte secondary battery including an alloyable active material (hereinafter may be referred to as an “alloy-type secondary battery”) has excellent battery performance, but may suddenly exhibit significant cycle deterioration (capacity decrease) when the number of charge and discharge cycles reaches several hundreds of times. Sudden cycle deterioration of a battery may impede the normal operation of the device powered by the battery. In such cases, it is predicted that a computer would suddenly stop operating and data being processed would be lost. In the case of an electric vehicle, it is predicted that while driving, the drive motor would suddenly stop, which can cause a problem with driving.

Also, shortly after the sudden occurrence of significant cycle deterioration, the battery often swells significantly. Thus, sudden cycle deterioration can affect the safety of the battery and the device powered by the battery. As described above, significant cycle deterioration of alloy-type secondary batteries occurs suddenly. It is thus very difficult to predict whether or not significant cycle deterioration can occur in advance.

It has been common practice to detect voltage change during charge and discharge of secondary batteries, time necessary for voltage change to take place, temperature during voltage change, etc., estimate the remaining capacities of secondary batteries, and display them. Patent Literature 1 discloses a battery pack including a secondary battery, comparison means for calculating the amount of voltage change of the secondary battery and comparing the calculated amount of voltage change with a set value, and means for opening and closing the circuit according to an instruction from the comparison means.

Patent Literature 1 uses a non-aqueous electrolyte secondary battery including a positive electrode, a negative electrode, and a non-aqueous electrolyte, wherein the positive electrode includes at least two active materials with different operating potentials and the negative electrode comprises Li or a Li alloy. The remaining capacity is estimated from the amount of voltage change of the battery, based on the fact that the positive electrode includes the active materials with different operating voltages. However, the remaining capacity is a reference value used to perform the next charge, not a reference value which indicates the replacement time of the battery.

Also, Patent Literature 1 estimates battery replacement time from the proportional relationship between discharge capacity and the number of charge and discharge cycles. However, the proportional relationship exists only between the number of charge and discharge cycles up to approximately 200 cycles and discharge capacity. Batteries usually do not deteriorate when subjected to approximately 200 cycles. It is thus difficult to accurately estimate battery replacement time from the above-mentioned proportional relationship.

Patent Literature 2 discloses an apparatus for estimating battery capacity, and this apparatus calculates battery capacity from the relationship between the state of charge (SOC) of a non-aqueous electrolyte secondary battery and temperature. FIG. 1 of Patent Literature 2 is a semilogarithmic graph showing that battery temperature and the rate of decrease of battery capacity have a linear relationship at different SOC values. Based on this graph, battery capacity is calculated.

However, users of batteries do not charge the batteries such that SOC is constant. They often stop charging the batteries. Also, they may apply a charge which is not yet necessary. Thus, estimating the replacement time of secondary batteries based on the graph shown in FIG. 1 of Patent Literature 2 can result in large errors.

Patent Literature 3 discloses a battery pack including a flat battery, a label wrapped around the battery, and means for detecting swelling. The means for detecting swelling is notches formed in the surface of the label. When the battery swells due to cycle deterioration, the battery develops slit-like cracks along the notches due to the stress of battery swelling. Battery deterioration is determined by observing such cracks.

However, in the case of alloy-type secondary batteries, battery swelling often increases after the occurrence of sudden cycle deterioration. Of course, before the occurrence of cycle deterioration, batteries swell slightly, but hardly exhibit swelling large enough to cause slit-like cracks in the label. Therefore, the technique of Patent Literature 3 cannot predict significant cycle deterioration of alloy-type secondary batteries in advance.

### [Citation List]

### [Patent Literatures]

[Patent Literature 1] Japanese Laid-Open Patent Publication No. Hei 6-290779
[Patent Literature 2] Japanese Laid-Open Patent Publication No. 2000-228227
[Patent Literature 3] Japanese Laid-Open Patent Publication No. 2009-009734

### SUMMARY OF INVENTION

### Technical Problem

An object of the invention is to provide a battery pack including an alloy-type secondary battery and a mechanism capable of accurately determining the replacement time of the alloy-type secondary battery or the presence or absence of cycle deterioration.

### Solution to Problem

The battery pack of the invention includes a non-aqueous electrolyte secondary battery, thickness detection means, cycle number detection means, and determination means.

In the battery pack of the invention, the non-aqueous electrolyte secondary battery includes an electrode assembly, a lithium-ion conductive non-aqueous electrolyte, and a battery case. The electrode assembly includes a positive electrode including a positive electrode active material capable of absorbing and desorbing lithium, a negative electrode including an alloyable active material, and an insulating layer interposed between the positive electrode and the negative electrode. The battery case houses the electrode assembly and the lithium-ion conductive non-aqueous electrolyte.

In the battery pack of the invention, the thickness detection means detects the thickness of the electrode assembly. The cycle number detection means detects the number of charge and discharge cycles of the non-aqueous electrolyte secondary battery. The determination means determines the replacement time of the non-aqueous electrolyte secondary battery or the presence or absence of cycle deterioration of the non-aqueous electrolyte secondary battery according to the detection result by the thickness detection means and the detection result by the cycle number detection means.

### Advantageous Effects of Invention

The battery pack of the invention, which includes an alloy-type secondary battery, has a high capacity and a high output. Also, the battery pack of the invention can almost accurately estimate the replacement time of the alloy-type secondary battery and the presence or absence of cycle deterioration thereof, without necessitating a large design change or a large increase in dimensions compared with conventional battery packs. It is thus possible to suppress sudden shutdown of electric/electronic devices powered by the battery pack of the invention. Also, since the battery pack of the invention does not necessitate a large increase in dimensions, it can be used in electronic devices that are increasingly becoming smaller and thinner.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a block diagram schematically showing the configuration of a battery pack in a first embodiment of the invention;

FIG. 2 is a longitudinal sectional view schematically showing the configuration of a non-aqueous electrolyte secondary battery included in the battery pack of FIG. 1;

FIG. 3 is a flow chart showing one embodiment of a method for determining the replacement time of the non-aqueous electrolyte secondary battery illustrated in FIG. 2;

FIG. 4 is a graph schematically showing the relationship between the number of charge and discharge cycles and the thickness of the electrode assembly of the non-aqueous electrolyte secondary battery illustrated in FIG. 2;

FIG. 5 is a block diagram schematically showing the configuration of a battery pack in a second embodiment of the invention;

FIG. 6 is a block diagram schematically showing the configuration of a battery pack in a third embodiment of the invention;

FIG. 7 is a flow chart showing one embodiment of a method for determining cycle deterioration of the non-aqueous electrolyte secondary battery illustrated in FIG. 2;

FIG. 8 is a perspective view schematically showing the configuration of a negative electrode current collector in another embodiment;

FIG. 9 is a longitudinal sectional view schematically showing the configuration of a negative electrode in another embodiment including the negative electrode current collector of FIG. 8;

FIG. 10 is a longitudinal sectional view schematically showing the configuration of a column included in a negative electrode active material layer of the negative electrode illustrated in FIG. 9;

FIG. 11 is a side view schematically showing the configuration of an electron beam deposition device; and

FIG. 12 is a side view schematically showing the configuration of an electron beam deposition device in another embodiment.

### DESCRIPTION OF EMBODIMENTS

### First Embodiment

In the process of finding solutions to the above-noted problems, the present inventors have focused on electrode assemblies that are prepared by winding or laminating a positive electrode, a negative electrode including an alloyable active material, and an insulating layer interposed between the positive and negative electrodes. They have found that in electrode assemblies including alloyable active materials, there is a correlation between the thickness of the electrode assembly and the number of charge and discharge cycles. Based on the finding, the present inventors have conducted further studies, and found that the replacement time of batteries can be estimated almost accurately by detecting the change in the thickness of the electrode assembly, thereby completing the invention.

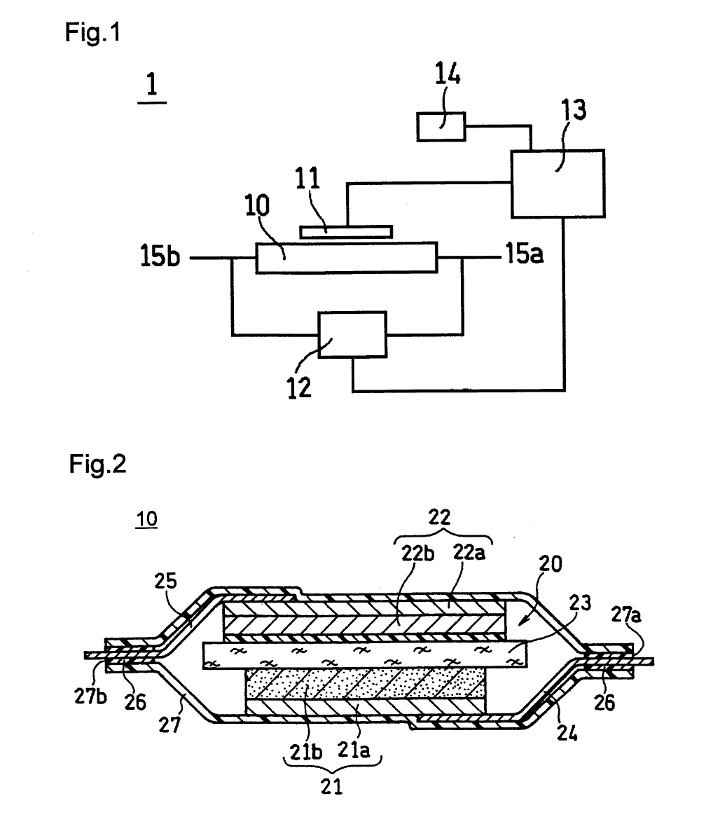

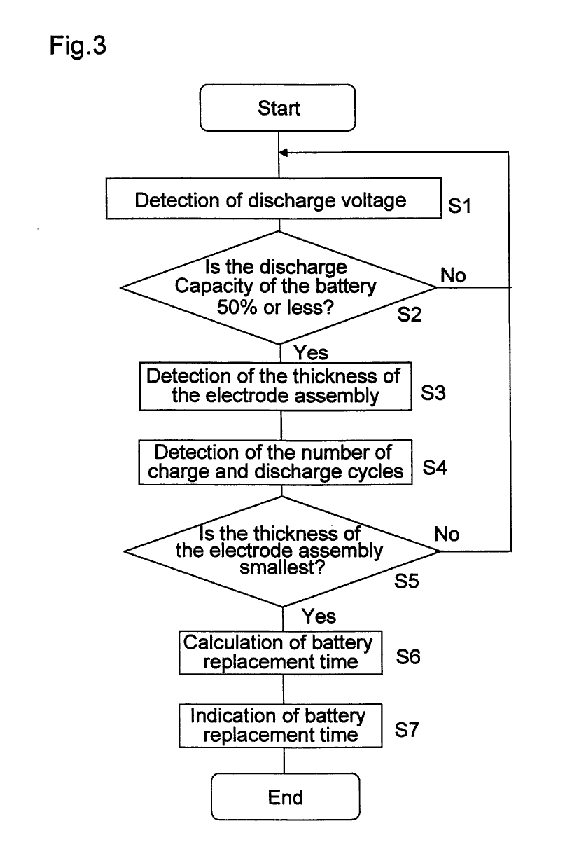

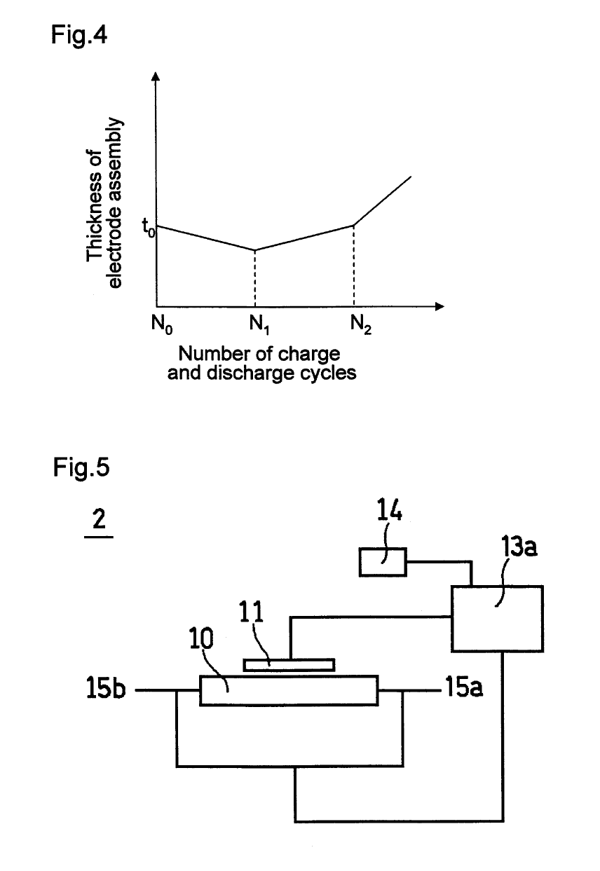

FIG. 1 is a block diagram schematically showing the configuration of a battery pack 1 in a first embodiment of the invention. FIG. 2 is a longitudinal sectional view schematically showing the configuration of a non-aqueous electrolyte secondary battery 10 included in the battery pack 1 of FIG. 1. FIG. 3 is a flow chart showing one embodiment of a method for determining the replacement time of the non-aqueous electrolyte secondary battery 10 illustrated in FIG. 2. FIG. 4 is a graph schematically showing the relationship between the number of charge and discharge cycles and the thickness of the electrode assembly of the non-aqueous electrolyte secondary battery 10 illustrated in FIG. 2.

The battery pack 1 includes the non-aqueous electrolyte secondary battery 10, thickness detection means 11, cycle number detection means 12, first determination means 13, replacement time indication means 14, and a housing (not shown).

### (1) Non-Aqueous Electrolyte Secondary Battery 10

The non-aqueous electrolyte secondary battery 10 (hereinafter abbreviated as the “battery 10”) is a flat lithium ion secondary battery including a laminated electrode assembly 20 that is prepared by laminating a positive electrode 21, a negative electrode 22, and a separator 23 interposed therebetween. The laminated electrode assembly 20 and a lithium-ion conductive non-aqueous electrolyte (not shown) (hereinafter may be referred to as simply a “non-aqueous electrolyte”) are housed in a battery case 27. In the battery 10, the separator 23 is used as an insulating layer.

One end of a positive electrode lead 24 is connected to a positive electrode current collector 21a, while the other end is drawn from one opening 27a of the battery case 27 and connected to an external connection terminal 15a. One end of a negative electrode lead 25 is connected to a negative electrode current collector 22a, while the other end is drawn from the other opening 27b of the battery case 27 and connected to an external connection terminal 15b.

The battery case 27 of this embodiment is a laminate film container having the openings 27a and 27b at both ends. After the laminated electrode assembly 20 and the non-aqueous electrolyte are placed in the battery case 27, the pressure inside the battery case 27 is reduced, and gaskets 26 are fitted and welded to the openings 27a and 27b, respectively, to obtain the battery 10. Also, the openings 27a and 27b can be directly welded without using the gaskets 26.

The laminated electrode assembly 20 (hereinafter referred to as the “electrode assembly 20”) includes the positive electrode 21, the negative electrode 22, and the separator 23. The separator 23 is interposed between the positive electrode 21 and the negative electrode 22.

The positive electrode 21 includes the positive electrode current collector 21a and a positive electrode active material layer 21b.

The positive electrode current collector 21a can be a conductive substrate such as a porous conductive substrate or a non-porous conductive substrate. Examples of materials for conductive substrates include metal materials such as stainless steel, titanium, aluminum, and aluminum alloys, and conductive resins. Examples of porous conductive substrates include mesh, net, punched sheets, lath, porous materials, foam, and non-woven fabric. Examples of non-porous conductive substrates include foil, sheets, and films. The thickness of the conductive substrate is usually 1 to 500 μm, preferably 5 to 100 μm, and more preferably 8 to 50 μm.

In this embodiment, the positive electrode active material layer 21b is provided on a surface of the positive electrode current collector 21a in the thickness direction thereof, but may be provided on both surfaces thereof in the thickness direction. The positive electrode active material layer 21b includes a positive electrode active material, and may further contain a conductive agent, a binder, etc.

The positive electrode active material can be a material commonly used in the field of non-aqueous electrolyte secondary batteries. Among them, for example, lithium-containing composite oxides and olivine-type lithium phosphates are preferable.

Lithium-containing composite oxides are metal oxides containing lithium and one or more transition metal elements, or such metal oxides in which part of the transition metal element(s) is replaced with different element(s). Examples of transition metal elements include Sc, Y, Mn, Fe, Co, Ni, Cu, and Cr. For example, Mn, Co, and Ni are preferable. Examples of different elements include Na, Mg, Zn, Al, Pb, Sb, and B. For example, Mg and Al are preferable. These transition metal elements and different elements may be used singly or in combination, respectively.

Examples of lithium-containing composite oxides include LiCoO₂, LiₗNiO₂, LiₗMnO₂, LiₗCoₘM₁₋ₘO₂, LiₗCoₘM₁₋ₘOₙ, LiₗNi₁₋ₘMₘOₙ, LiₗMn₂O₄, and LiₗMn₂₋ₙMₘO₄ where M is at least one element selected from the group consisting of Sc, Y, Mn, Fe, Co, Ni, Cu, Cr, Na, Mg, Zn, Al, Pb, Sb, and B, 0<1≦1.2, 0≦m≦0.9, and 2.0≦n≦2.3. Among them, LiₗCoₘM₁₋ₘOₙ is preferable.

Examples of olivine-type lithium phosphates include LiXPO₄ and Li XPO₄F where X is at least one element selected from the group consisting of Co, Ni, Mn, and Fe. In the respective formulae of lithium-containing composite oxides and olivine-type lithium phosphates, the molar ratio of lithium is a value immediately after the preparation of the positive electrode active material, and decreases and increases due to charge and discharge.

These positive electrode active materials can be used singly or in combination.

The conductive agent can be one commonly used in the field of non-aqueous electrolyte secondary batteries. Examples include graphites such as natural graphite and artificial graphite, carbon blacks such as acetylene black, ketjen black, channel black, furnace black, lamp black, and thermal black, conductive fibers such as carbon fiber and metal fiber, metal powders such as aluminum, and fluorinated carbon. These conductive agents can be used singly or in combination.

The binder can be a polymeric material. Examples of polymeric materials include resin materials such as polyvinylidene fluoride, polytetrafluoroethylene, polyethylene, polypropylene, aramid resins, polyamides, polyimides, polyamide-imides, polyacrylnitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinyl pyrrolidone, polyether, polyethersulfone, and polyhexafluoropropylene, rubber materials such as styrene butadiene rubber and modified acrylic rubber, and water-soluble polymeric materials such as carboxymethyl cellulose.

The polymeric material can be a copolymer including two or more monomer compounds. Examples of monomer compounds include tetrafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene.

These binders can be used singly or in combination.

The positive electrode active material layer 21b can be formed by applying a positive electrode mixture slurry onto a surface of the positive electrode current collector 21a to form a coating, drying the coating, and rolling it. The positive electrode mixture slurry can be prepared by dissolving or dispersing a positive electrode active material and, if necessary, a conductive agent, a binder, etc. in an organic solvent. As the organic solvent, it is possible to use dimethylformamide, dimethylacetamide, methylformamide, N-methyl-2-pyrrolidone, dimethylamine, acetone, and cyclohexanone.

The negative electrode 22 includes the negative electrode current collector 22a and a negative electrode active material layer 22b.

The negative electrode current collector 22a comprises a non-porous conductive substrate. Examples of materials of conductive substrates are metal materials such as stainless steel, titanium, nickel, copper, and copper alloys. Examples of non-porous conductive substrates include foil and films. While the thickness of the conductive substrate is not particularly limited, it is usually 1 to 500 μm, preferably 5 to 100 μm, and more preferably 8 to 50 μm.

In this embodiment, the negative electrode active material layer 22b is provided on a surface of the negative electrode current collector 22a in the thickness direction thereof, but may be provided on both surfaces thereof in the thickness direction. The negative electrode active material layer 22b includes an alloyable active material, and may further contain known negative electrode active materials other than alloyable active materials, additives, etc. unless its characteristics are impaired. The negative electrode active material layer 22b is preferably an amorphous or low-crystalline thin film including an alloyable active material and having a thickness of 1 to 20 μm.

An alloyable active material absorbs lithium by alloying with lithium, and reversibly absorbs and desorbs lithium at a negative electrode potential. Examples of alloyable active materials include silicon-based active materials and tin-based active materials. These alloyable active materials can be used singly or in combination.

Examples of silicon-based active materials include silicon, silicon compounds, partially replaced compounds, and solid solutions of silicon compounds or partially replaced compounds. Examples of silicon compounds include silicon oxides represented by the formula Siₐ where 0.05<a<1.95, silicon carbides represented by the formula SiC_{b} where 0<b<1, silicon nitrides represented by the formula SiN_{c} where 0<c<4/3, and silicon alloys. Silicon alloys are alloys containing silicon and at least one different element (A) selected from the group consisting of Fe, Co, Sb, Bi, Pb, Ni, Cu, Zn, Ge, In, Sn and Ti.

Partially replaced compounds are compounds in which part of the silicon atoms contained in silicon and silicon compounds is replaced with at least one different element (B) selected from the group consisting of B, Mg, Ni, Ti, Mo, Co, Ca, Cr, Cu, Fe, Mn, Nb, Ta, V, W, Zn, C, N, and Sn. Among them, silicon and silicon compounds are preferable, and silicon oxides are more preferable.

Examples of tin-based active materials include tin, tin compounds, tin oxides represented by the formula SnO_{d} where 0<d<2, tin dioxide (SnO₂), tin nitrides, tin alloys such as a Ni—Sn alloy, a Mg—Sn alloy, an Fe—Sn alloy, a Cu—Sn alloy, and a Ti—Sn alloy, tin compounds such as SnSiO₃, Ni Sn₄, and Mg₂Sn, and solid solutions thereof. Among tin-based active materials, for example, tin oxides, tin alloys, and tin compounds are preferable. Among alloyable active materials, for example, silicon, silicon oxides, and tin oxides are preferable, and silicon oxides are more preferable.

The negative electrode active material layer 22b is formed by a vapor deposition method. Examples of vapor deposition methods include vacuum deposition, sputtering, ion plating, laser ablation, chemical vapor deposition (CVD), plasma chemical vapor deposition, and thermal spraying. Among them, vacuum deposition is preferable.

For example, in an electron beam vacuum deposition device, the negative electrode current collector 22a is disposed vertically above a silicon target. The silicon target is irradiated with an electron beam to produce silicon vapor, so that the silicon vapor is deposited on a surface of the negative electrode current collector 22a. As a result, the negative electrode active material layer 22b made of silicon is formed on the surface of the negative electrode current collector 22a. At this time, when oxygen or nitrogen is supplied into the electron beam vacuum deposition device, the negative electrode active material layer 22b including a silicon oxide or a silicon nitride is formed.

The negative electrode active material layer 22b of this embodiment is formed as a solid film, but is not to be limited thereto. It may be formed in a pattern such as a lattice by a vapor deposition method, or may be formed so as to include a plurality of columns. The columns are formed so that they each include an alloyable active material and extend outwardly from the surface of the negative electrode current collector, with a gap between a pair of adjacent columns.

In this case, it is preferable to form a plurality of protrusions on the negative electrode current collector surface regularly or irregularly and form a column on the surface of each of the protrusions. The shape of the protrusions in orthographic projection seen from vertically above can be rhombic, circular, oval, triangular to octagonal, and the like. When the protrusions are formed regularly, the protrusions can be arranged on the negative electrode current collector surface in a grid pattern, a lattice pattern, a houndstooth check pattern, a close-packed pattern, or the like. Also, the protrusions are formed on one surface or both surfaces of the negative electrode current collector in the thickness direction. The height of the columns is preferably 3 μm to 30 μm.

The separator 23 is a lithium-ion permeable insulating layer interposed between the positive electrode 21 and the negative electrode 22. The separator 23 may have lithium ion conductivity. The separator 23 can be a porous film having pores. The porous film can be a micro-porous film, woven fabric, non-woven fabric, or the like. The micro-porous film can be a mono-layer film or a multi-layer film (composite film). Also, the separator 23 may be composed of a laminate of two or more layers such as a microporous film, woven fabric, and non-woven fabric.

While various resin materials can be used as the material of the separator 23, polyolefins such as polyethylene and polypropylene are preferable in consideration of durability, shutdown function, battery safety, etc. The thickness of the separator 23 is usually 5 to 300 μm, preferably 8 to 40 μm, and more preferably 10 to 30 μm. The porosity of the separator 23 is preferably 30 to 70%, and more preferably 35 to 60%. The porosity as used herein refers to the ratio of the total volume of the pores in the separator 23 to the volume of the separator 23.

The electrode assembly 20 and the separator 23 are impregnated with a lithium-ion conductive non-aqueous electrolyte. The non-aqueous electrolyte used in this embodiment is a liquid non-aqueous electrolyte. The liquid non-aqueous electrolyte includes a solute (supporting salt) and a non-aqueous solvent, and may further contain various additives.

Examples of the solute include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylates, LiCl, LiBr, LiI, LiBCl₄, borates, and imide salts. These solutes can be used singly or in combination. The amount of the solute dissolved is preferably 0.5 to 2 mol per liter of the non-aqueous solvent.

Examples of the non-aqueous solvent include cyclic carbonic acid esters, chain carbonic acid esters, and cyclic carboxylic acid esters. Cyclic carbonic acid esters include propylene carbonate, ethylene carbonate, and the like. Chain carbonic acid esters include diethyl carbonate, ethyl methyl carbonate, dimethyl carbonate, and the like. Cyclic carboxylic acid esters include γ-butyrolactone, γ-valerolactone, and the like. These non-aqueous solvents can be used singly or in combination.

Examples of additives include vinylene carbonate compounds which increase coulombic efficiency and benzene compounds which inactivate batteries. Vinylene carbonate compounds include vinylene carbonate, vinyl ethylene carbonate, and divinyl ethylene carbonate. Benzene compounds include cyclohexyl benzene, biphenyl, and diphenyl ether.

Instead of a liquid non-aqueous electrolyte, it is also possible to use a gel non-aqueous electrolyte. The gel non-aqueous electrolyte includes a liquid non-aqueous electrolyte and a polymeric material. The polymeric material can be polyvinylidene fluoride, polyacrylonitrile, polyethylene oxide, polyvinyl chloride, polyacrylate, or the like.

In the battery 10 of this embodiment, the separator 23 is used as the insulating layer, but a porous heat-resistant layer can also be used instead of the separator 23. Also, the separator 23 and a porous heat-resistant layer can be used in combination. The porous heat-resistant layer is formed, for example, on a surface of at least one of the positive electrode active material layer 21b and the negative electrode active material layer 22b.

The porous heat-resistant layer includes an inorganic oxide and a binder. Examples of inorganic oxides include alumina, titania, silica, magnesia, and calcia. As the binder, various polymeric materials can be used. The content of the inorganic oxide in the porous heat-resistant layer is preferably 90 to 99.5% by weight of the total amount of the porous heat-resistant layer, with the remainder being the binder.

The porous heat-resistant layer can be formed in the same manner as the positive electrode active material layer 21b. The porous heat-resistant layer can be formed by dissolving or dispersing an inorganic oxide and a binder in an organic solvent to form a slurry, applying the slurry onto a surface of the positive electrode active material layer 21b and/or the negative electrode active material layer 22b, and drying it. The thickness of the porous heat-resistant layer is preferably 1 to 10 μm.

Also, in the battery 10 of this embodiment, a solid electrolyte layer can be used as the insulating layer instead of the separator 23 and the liquid non-aqueous electrolyte. The solid electrolyte layer includes a solid electrolyte such as an inorganic solid electrolyte or an organic solid electrolyte. Examples of inorganic solid electrolytes include sulfide-based inorganic solid electrolytes, oxide-based inorganic solid electrolytes, other lithium-based inorganic solid electrolytes, and glass ceramics obtained by crystallizing these inorganic solid electrolytes.

Examples of sulfide-based inorganic solid electrolytes include (Li₃PO₄)ₓ—(Li₂S)_{y}—(SiS₂)_{z} glass, (Li₂S)ₓ—(SiS₂)_{y}, (Li₂S)ₓ—(P₂S₅)_{y}, Li₂S—P₂S₅, and thio-LISICON. Examples of oxide-based inorganic solid electrolytes include NASICON types such as LiTi₂(PO₄)₃, LiZr₂(PO₄)₃, and LiGe₂(PO₄)₃, and perovskite types such as (La_{0.5+x}Li_{0.5-3x})TiO₃. Examples of other lithium-based inorganic solid electrolytes include LiPON, LiNbO₃, LiTaO₃, Li₃PO₄, LiPO₄₋ₓNₓ where 0<x≦1, LiN, LiI, and LISICON.

Examples of organic solid electrolytes include ion conductive polymers and polymer electrolytes.

Examples of ion conductive polymers include polyethers with low phase-transition temperatures (Tg), amorphous vinylidene fluoride copolymer, and mixtures of different polymers.

An example of polymer electrolytes is a polymer electrolyte containing a matrix polymer and a lithium salt. Examples of matrix polymers include polyethylene oxide, polypropylene oxide, a copolymer of ethylene oxide and propylene oxide, polymers having an ethylene oxide unit and/or a propylene oxide unit, and polycarbonate. As the lithium salt, the same materials as the solutes of liquid non-aqueous electrolyte can be used.

The respective components of the battery 10 are further described. The positive electrode lead 24 is made of a material such as aluminum. The negative electrode lead 25 is made of a material such as nickel, copper, or a copper alloy. The gasket 26 is made of a material such as polyolefin or fluorocarbon resin.

The battery case 27 is a rectangular pouch, made of a laminate film, which has the openings 27a and 27b at both ends in the longitudinal direction thereof. Examples of laminate films are laminates of metal foils and resin films, such as a laminate film of acid-modified polypropylene/polyethylene terephthalate (PET)/Al foil/PET, a laminate film of acid-modified polyethylene/polyamide/Al foil/PET, a laminate film of an ionomer resin/Ni foil/polyethylene/PET, a laminate film of ethylene vinyl acetate/polyethylene/Al foil/PET, and a laminate film of an ionomer resin/PET/Al foil/PET.

The material of the battery case 27 in this embodiment is a laminate film, but is not limited thereto. It may be a metal material, a resin material, or the like. Examples of metal materials include aluminum, magnesium, titanium, iron, stainless steel, and alloys thereof. Examples of resin materials include fluorocarbon resin, ABS resin, polycarbonate, and polyethylene terephthalate.

The battery 10 of this embodiment is a laminate-film packed battery including the electrode assembly 20, but is not limited thereto. It may be a cylindrical battery including a wound electrode assembly, a prismatic battery including a flat electrode assembly obtained by press-molding a wound electrode assembly into a flat shape, or a coin battery including a laminated electrode assembly.

### (2) Thickness Detection Means 11

The thickness detection means 11 detects the thickness of the electrode assembly 20 of the battery 10. The thickness detection means 11 is connected to the first determination means 13 such that information is exchangeable therebetween, for example, by electrical connection and optical connection. The thickness detection means 11 detects the inner pressure (thickness information) of the electrode assembly 20 of the battery 10 and calculates the thickness of the electrode assembly 20. Also, the thickness detection means 11 outputs the detection result (calculation result) to the first determination means 13. The thickness detection means 11 is disposed, for example, near the battery 10, and includes pressure detection means, voltage detection means, first storage means, first computation means, and first control means, which are not shown. The pressure detection means and the voltage detection means are preferably disposed near the battery 10.

The pressure detection means detects the inner pressure of the electrode assembly 20 of the battery 10. In this embodiment, the pressure detection means is brought into contact with the central part of the flat portion of the battery 10, to detect the inner pressure of the electrode assembly 20. The flat portion of the battery 10 refers to the portion of the battery case 27 containing the electrode assembly 20. In order to accurately detect the inner pressure of the electrode assembly 20 by the pressure detection means, the electrode assembly 20 is preferably a laminated electrode assembly or a flat electrode assembly.

The central part of the battery 10 is the portion of the battery case 27 facing the center of the electrode assembly 20 in the thickness direction of the battery case 27. When the electrode assembly 20 is a laminated electrode assembly or a flat electrode assembly, it has a quadrangular shape when seen from vertically above (upper part in FIG. 2). The point of intersection of the diagonal lines of the quadrangle is the center of the electrode assembly 20. The central part of the battery 10 does not need to accurately agree with the center of the electrode assembly 20, and the inner pressure of the electrode assembly 20 can also be detected almost accurately in the vicinity of the center of the electrode assembly 20. The vicinity of the center of the electrode assembly 20 refers to, for example, a circular area within a radius of 5 to 10 mm from the center of the electrode assembly 20.

Also, in terms of detecting the inner pressure of the electrode assembly 20 with the battery case 27 therebetween, it is preferable to make the dimensions of the battery case 27 equal to those of the electrode assembly 20. Alternatively, it is preferable to make the dimensions of the electrode assembly 20 equal to those of the battery case 27. In particular, it is desirable to design the thickness of the inner space of the battery case 27 and the thickness of the electrode assembly 20 to be almost the same. Also, the material of the battery case 27 is preferably a laminate film, a flexible synthetic resin material, a metal material that can be deformed relatively easily by an external stress, or the like.

The pressure detection means detects the inner pressure of the electrode assembly 20, for example, when the open circuit voltage (hereinafter “OCV”) of the battery 10 during discharge reaches 50% or less of the OCV value immediately after charge (upon the start of discharge). The pressure detection means can be, for example, a pressure sensor. While the pressure sensor is not particularly limited, it is preferably a small pressure sensor, since it is used in the battery pack 1. Various small pressure sensors are commercially available, and examples include HSPC series (trade name; available from ALPS ELECTRIC CO., LTD.) and PS-A pressure sensor (trade name; available from Panasonic Electric Works Co., Ltd.).

The voltage detection means measures the OCV value of the battery 10. First, the voltage detection means detects the OCV value of the battery 10 upon the start of discharge and outputs the detection result to the first storage means. Further, the voltage detection means measures the OCV value of the battery 10 at a predetermined interval and outputs the detection result to the first storage means. Various voltmeters can be used as the voltage detection means. Every time a new detection result by the voltage detection means is input in the first storage means, the first control means compares the OCV value upon the start of discharge with the newly input OCV value and determines whether or not the newly input OCV value is 50% or less of that upon the start of discharge.

If the discharge of the battery 10 is stopped before the OCV value reaches 50% or less of the OCV value upon the start of discharge, a determination is made based on the OCV value upon the start of the discharge, unless the battery 10 is charged. Every time the battery 10 is charged and the OCV value upon the start of discharge is measured, the OCV value upon the start of discharge in the first storage means is updated to a new value.

The first storage means stores data on the battery 10. Examples of data include the initial thickness of the negative electrode active material layer 22b, the initial thickness of the electrode assembly 20, the number of the electrode assemblies 20 laminated, and the number of times the electrode assembly 20 is wound. Also, the first storage means stores a first data table showing the relationship between the inner pressure of the electrode assembly 20 and thickness based on the initial thickness of the negative electrode active material layer 22b, the initial thickness of the electrode assembly 20, and the number of the electrode assemblies 20 laminated or the number of times the electrode assembly 20 is wound. The first data table is prepared in advance by experiments.

More specifically, in the electrode assembly 20 including an alloyable active material as the negative electrode active material, there is a relation: Y=αX+T₀ between the inner pressure X of the electrode assembly 20, the thickness Y of the electrode assembly 20, and the initial thickness T₀ of the electrode assembly 20. Thus, the proportionality constant α in the relation is determined according to the number of the electrode assemblies 20 laminated or the number of times the electrode assembly 20 is wound, and is input in the first storage means as the first data table in advance. In this case, it is preferable to set the number of the electrode assemblies 20 laminated or the number of times the electrode assembly 20 is wound, not continuously like 1, 2, 3 . . . , but in stages, for example, 1 to 5, 6 to 10, 11 to 15 . . . , by setting numerical ranges, and determine the proportionality constant α for each numerical range. To determine the proportionality constant α_{1 to 5} for the numerical range of 1 to 5, the proportionality constants α₁ to α₅ for the respective numerical values of 1 to 5 are determined, and the average value thereof is used as the proportionality constant α_{1 to 5}.

To determine the proportionality constant α, it is necessary to determine the number of the electrode assemblies 20 laminated or the number of times the electrode assembly 20 is wound. The number of the electrode assemblies 20 laminated or the number of times the electrode assembly 20 is wound is determined when the new battery 10 is mounted in the battery pack 1. When the new battery 10 is mounted in the battery pack 1, it is usually not in a fully charged state, and thus, a first charge is applied to fully charge the battery 10. After the first charge, the OCV value upon the start of discharge is detected by the voltage detection means.

The detection result by the voltage detection means is input into the first storage means. Also, in addition to the first data table, the first storage means stores a second data table showing the relationship between the number of the electrode assemblies 20 laminated or the number of times the electrode assembly 20 is wound and the OCV value upon the start of discharge after the first charge. In the second data table, the number of the electrode assemblies 20 laminated or the number of times the electrode assembly 20 is wound is also set in stages (numerical ranges), in the same manner as in the first data table. The first computation means compares the detection result by the voltage detection means (the OCV value upon the start of discharge after the first charge) with the second data table, determines the number of the electrode assemblies 20 of the battery 10 laminated or the number of times the electrode assembly 20 thereof is wound, and outputs it to the first storage means. It is noted that the number of lamination or winding can be stored in the first storage means in advance.

The first computation means calculates the thickness of the electrode assembly 20 based on the detection result by the pressure detection means (the inner pressure value of the electrode assembly 20), the number of the electrode assemblies 20 laminated or the number of times the electrode assembly 20 is wound, and the first data table.

Further, the first storage means stores a program which calculates the thickness of the electrode assembly 20 from the first data table based on the detection result by the pressure detection means. The thickness of the electrode assembly 20 is calculated by the method as described above. This program is performed by the first computation means. Also, the detection result by the pressure detection means is input into the first storage means. This detection result is rewritten every time a new detection result is input.

Every time a new detection result by the pressure detection means is input into the first storage means, the first computation means retrieves the detection result and the first data table from the first storage means and calculates the thickness of the electrode assembly 20. The first computation means outputs the calculation result to the first determination means 13.

The first control means controls the voltage detection means so that it measures the OCV value upon the start of discharge after the battery 10 is charged and thereafter measures the OCV value at a predetermined interval of time. Also, the first control means outputs a control signal to the pressure detection means according to a determination result by the first computation means that “the OCV value is 50% or less of the OCV value upon the start of discharge”, thereby causing the pressure detection means to detect the inner pressure of the electrode assembly 20. Simultaneously with the output of the control signal to the pressure detection means, the first control means outputs a control signal to the second control means of the cycle number detection means 12, thereby causing the cycle number detection means 12 to detect the number of cycles.

In this embodiment, the first storage means, the first computation means, and the first control means comprise a processing circuit including a micro computer, an interface, memory, a timer, etc. Various memories commonly used in this field can be used as the first storage means, and examples include read only memory (ROM), random access memory (RAM), semiconductor memory, nonvolatile flash memory, and the like.

### (3) Cycle Number Detection Means 12

The cycle number detection means 12 detects the cumulative number of charge and discharge cycles of the battery 10 upon the detection of the inner pressure of the electrode assembly 20 by the thickness detection means 11. In this embodiment, a charge and discharge cycle refers to a full charge of the battery 10 and a subsequent discharge until another charge becomes necessary. The cycle number detection means 12 is electrically or optically connected to the first determination means 13, and outputs the detection result to the first determination means 13. In this embodiment, the cycle number detection means 12 includes voltage detection means, second storage means, second computation means, and second control means, which are not shown.

The voltage detection means detects the OCV value of the battery 10 during discharge and charge at a regular interval. The OCV value detection by the voltage detection means is performed at a shorter predetermined interval than a charge and discharge cycle. The voltage detection means can be, for example, a voltmeter. The detection results over time by the voltage detection means are input into the second storage means. When the second computation means determines that the OCV value of the battery 10 during discharge has reached 50% or less of the OCV value immediately after charge (upon the start of discharge), the cycle number detection means 12 outputs the determination result to the first determination means 13. As a result, the thickness detection means 11 starts detecting the inner pressure of the electrode assembly 20. It is noted that one voltage detection means may be shared by the thickness detection means 11 and the cycle number detection means 12.

The second storage means stores the detection results over time by the voltage detection means. Also, the second storage means stores the determination results (the number of charge and discharge cycles) determined by the second computation means according to the detection result by the voltage detection means. Every time the number of charge and discharge cycles increases, the second storage means adds the determination result with the latest determination result and stores the sum. Also, the second storage means stores a third data table showing the relationship between the OCV value and the number of the electrode assemblies 20 laminated or the number of times the electrode assembly 20 is wound. The third data table can be determined by experiments or the like in advance. In the third data table, the number of the electrode assemblies 20 laminated or the number of times the electrode assembly 20 is wound is set in stages, for example, 1 to 5, 6 to 10, and 11 to 15. This is the same as the data table stored in the first storage means of the thickness detection means 11.

Further, the second storage means stores a program for a method of determining the number of charge and discharge cycles by the second computation means, a program which determines the number of the electrode assemblies 20 of the battery 10 laminated or the number of times the electrode assembly 20 is wound based on the detection result by the voltage detection means and the third data table, and the like.

Every time a new detection result of the OCV value by the voltage detection means is input into the second storage means, the second computation means retrieves the detection results of the OCV value over time from the second storage means, and determines whether or not the number of charge and discharge cycles has increased by one cycle from the previous determination. When the second computation means has determined that the number of charge and discharge cycles has increased by one cycle, it outputs the determination result to the second storage means. Based on the newly input determination result, the second storage means adds “+1” to the latest number of charge and discharge cycles.

By detecting the OCV value of the battery 10 over time, it is possible to easily identify a charge and discharge cycle from the start of a charge of the battery 10, then completion of the charge, until another charge becomes necessary. Upon the start of a charge, the OCV value of the battery 10 is lowest; thereafter, the OCV value stably increases due to the charge; the OCV value gradually lowers and becomes the lowest due to a discharge after the completion of the charge. Detection of this cycle makes it possible to determine whether or not the number of charge and discharge cycle has increased by one cycle.

The second control means causes the second computation means to determine the number of charge and discharge cycles simultaneously with the start of detection of the inner pressure by the thickness detection means 11.

The cycle number detection means 12 detects the number of charge and discharge cycles simultaneously with the start of detection by the thickness detection means 11, and outputs the latest determination result (the number of charge and discharge cycles) by the second computation means to the first determination means 13 as the detection result.

The second computation means determines the number of the electrode assemblies 20 of the battery 10 laminated or the number of times the electrode assembly 20 is wound based on the detection result by the voltage detection means and the third data table. The second computation means outputs the determination result to the first determination means 13. The first determination means 13 uses this determination result, for example, to determine a set value (reference value) of the smallest thickness of the electrode assembly 20 of the battery 10.

The second storage means, the second computation means, and the second control means comprise a processing circuit including a micro computer, an interface, memory, a timer, etc., just like the first storage means, the first computation means, and the first control means. Various memories can be used as the second storage means, just like the first storage means. A single processing circuit can include the first storage means, the first computation means, and the first control means, as well as the second storage means, the second computation means, and the second control means.

### (4) First Determination Means 13

The first determination means 13 calculates the battery replacement time according to the detection result (calculation result) by the thickness detection means 11 and the detection result (determination result) by the cycle number detection means 12. More specifically, the first determination means 13 determines whether or not the thickness of the electrode assembly 20 detected by the thickness detection means 11 is smallest according to the detection result by the thickness detection means 11 and the detection result by the cycle number detection means 12, and calculates the battery replacement time according to a determination result that the thickness of the electrode assembly 20 is smallest.

More specifically, the first determination means 13 compares the detection result by the thickness detection means 11 with the set value (reference value) of the smallest thickness of the electrode assembly 20 to determine whether or not the detection result by the thickness detection means 11 is the smallest thickness of the electrode assembly 20. At this time, it determines that the thickness of the electrode assembly 20 is smallest when the detection result by the thickness detection means 11 is preferably in the range from the set value×0.90 to the set value×1.10, and more preferably in the range from the set value×0.95 to the set value×1.05. In the battery 10, the inner pressure and thickness of the electrode assembly 20 may change slightly from the set value, according to, for example, the material, shape, and dimensions of the battery case 27. Thus, in determining whether or not the thickness of the electrode assembly 20 is smallest, setting a small range as the set value enables more accurate determination of replacement time.

Also, without providing the first control means of the thickness detection means 11 and the second control means of the cycle number detection means 12, the first determination means 13 can be used in place of the first control means and the second control means. In this case, the first determination means 13 receives the determination result that the OCV value of the battery 10 during discharge has reached 50% or less of the OCV value immediately after charge, from the voltage detection means included in the thickness detection means 11 or the cycle number detection means 12. According to this determination result, the first determination means 13 sends a control signal to the thickness detection means 11 and the cycle number detection means 12, thereby causing the thickness detection means 11 to detect the thickness of the battery 10 and causing the cycle number detection means 12 to detect the number of charge and discharge cycles of the battery 10.

The first determination means 13 includes, for example, third storage means, third computation means, and third control means. The third storage means stores a fourth data table and a fifth data table in advance. The fourth data table shows the relationship between the smallest thickness of the electrode assembly 20 and the number of charge and discharge cycles at which the thickness of the electrode assembly 20 becomes smallest in relation to the number of the electrode assemblies 20 laminated or the number of times the electrode assembly 20 is wound. That is, in connection with the number of the electrode assemblies 20 laminated or the number of times the electrode assembly 20 is wound, the relation between the smallest thickness of the electrode assembly 20 and the number of charge and discharge cycles is set. The number of the electrode assemblies 20 laminated or the number of times the electrode assembly 20 is wound is set in stages, for example, 1 to 5, 6 to 10, and 11 to 15. The number of the electrode assemblies 20 laminated or the number of times the electrode assembly 20 is wound can be determined from the detection of the OCV value by the voltage detection means, as described above. The determination result of the number of the electrode assemblies 20 laminated or the number of times the electrode assembly 20 is wound is input into the third storage means of the first determination means 13 from the thickness detection means 11 or the cycle number detection means 12.

Hence, the third computation means determines whether or not the detection result by the thickness detection means 11 is the smallest thickness of the electrode assembly 20 from the fourth data table and the determination result of the number of the electrode assemblies 20 laminated or the number of times the electrode assembly 20 is wound. In this case, the third computation means also refers to the detection result by the cycle number detection means 12. It should be noted that when the detection result by the cycle number detection means 12 is less than the number of charge and discharge cycles corresponding to the smallest thickness of the electrode assembly 20 in the fourth data table, the third computation means does not determine that the thickness of the electrode assembly 20 has become smallest. In this case, the third computation means outputs a control signal to the first control means and causes the thickness detection means 11 to make a second detection. When the second detection has also determined that the thickness of the electrode assembly is smallest, even if the number of charge and discharge cycles detected does not agree with that in the fourth data table, the third computation means determines that the thickness of the electrode assembly has become smallest.

The fifth data table shows the relationship between the number Z of charge and discharge cycles and the thickness T of the electrode assembly 20 after the thickness of the electrode assembly 20 of the battery 10 has become smallest. This relationship can be determined by experiments in advance. Also, this relationship is determined in relation to the number of the electrode assemblies 20 laminated or the number of times the electrode assembly 20 is wound. In the fifth table, the number of the electrode assemblies 20 laminated or the number of times the electrode assembly 20 is wound is also set in stages (numerical ranges), for example, 1 to 5, 6 to 10, 11 to 15 . . . .

The present inventors have found that the battery 10 using an alloyable active material has a special relationship between the number of charge and discharge cycles and the thickness of the electrode assembly 20. That is, as shown in FIG. 4, from N₀, at which the use of the battery 10 is started, to N₁, which is at a predetermined number of charge and discharge cycles, there is an almost negatively proportional relationship between the thickness of the electrode assembly 20 and the number of charge and discharge cycles. The thickness of the electrode assembly 20 gradually decreases until the number of charge and discharge cycles reaches N₁, and the thickness of the electrode assembly 20 becomes smallest at the number N₁ of charge and discharge cycles. Thus, the smallest thickness of the electrode assembly 20 can be determined by experiments in advance. If the number of charge and discharge cycles becomes larger than N₁, the thickness of the electrode assembly 20 gradually increases. Such phenomenon of change in the thickness of the electrode assembly 20 is not found in non-aqueous electrolyte secondary batteries utilizing other negative electrode active materials than alloyable active materials.

Although the reason for the occurrence of such phenomenon in the battery 10 using an alloyable active material is not yet clear, it is probably because the shape of the alloyable active material particles in the negative electrode active material layer 22b is optimized by the expansion and contraction caused by repeated charge and discharge cycles. The optimization of particle shape means that due to a change in particle shape, the volume of the gaps between the particles becomes smallest so the volume of the negative electrode active material layer 22b comprising the particles becomes smallest.

The repeated charge and discharge cycles cause the alloyable active material particles to deteriorate as well as optimizing the particle shape. In this case, due to an increase in the thickness of the particles in the direction of the C axis, the thickness of the electrode assembly 20 and the number of charge and discharge cycles may exhibit an inversely proportional relationship. It is thus preferable to prepare the electrode assembly 20 in advance and identify a change in the thickness of the electrode assembly 20 due to an increase in the number of charge and discharge cycles.

Also, the reason why the thickness of the electrode assembly 20 increases when the number of charge and discharge cycles becomes larger than N₁ is probably that the optimization of particle shape of the alloyable active material particles is completed at the number N₁ of charge and discharge cycles.

Further, the present inventors have found that the replacement time of the battery 10 having the above-mentioned characteristics can be estimated almost accurately by detecting the smallest thickness of the electrode assembly 20 and the number N₁ of charge and discharge cycles at which the thickness becomes smallest. Specifically, the present inventors have found that there is a highly reproducible correlation between the thickness T of the electrode assembly and the number Z of charge and discharge cycles after the thickness of the electrode assembly 20 has become smallest. Hence, by preparing, by experiments, data on the relationship between the thickness T of the electrode assembly and the number Z of charge and discharge cycles after the thickness of the electrode assembly 20 has become smallest, it is possible to estimate the thickness T of the electrode assembly after the number Z of charge and discharge cycles.

Therefore, by setting the replacement time of the battery 10 based on the thickness T of the electrode assembly, it is possible to almost accurately estimate the number of charge and discharge cycles which can be applied before the battery 10 needs to be replaced. The replacement time of the battery 10 is determined from the thickness of the electrode assembly 20 of the battery 10. The thickness of the electrode assembly 20 of the battery 10 which needs to be replaced is the thickness of the electrode assembly 20, for example, when the capacity of the battery 10 becomes 50% or less of the initial capacity (the capacity upon the start of use). The thickness of the electrode assembly 20 of the battery which needs to be replaced is stored in the third storage means together with the fifth data table. That is, when a determination that the thickness of the electrode assembly 20 has become smallest is made, the battery pack 1 can almost accurately estimate the number of charge and discharge cycles which can be applied before the battery 10 needs to be replaced.

It should be noted that when the difference between the thickness of the electrode assembly corresponding to the number of charge and discharge cycles in the fifth data table and the detection result of the thickness of the electrode assembly by the thickness detection means 11 is 25% or more, the first determination means 13 regards such difference as abnormal and determines the number of charge and discharge cycles at that time as the replacement time of the battery 10.

The third computation means determines the smallest thickness of the electrode assembly 20 according to the number of the electrode assemblies 20 laminated or the number of times the electrode assembly 20 is wound, and according to the determination result, determines whether or not the detection result by the thickness detection means 11 is equal to the smallest thickness of the electrode assembly. When the detection result by the thickness detection means 11 is equal to the smallest thickness of the electrode assembly, the third computation means retrieves the number of charge and discharge cycles at that time and the fifth data table from the third storage means, calculates the number of charge and discharge cycles which can be applied before the battery 10 needs to be replaced, and outputs the calculation result to the third storage means.

Also, when the detection result by the thickness detection means 11 is larger than the smallest thickness of the electrode assembly, every time a detection result that the OCV value detected by the voltage detection means is 50% or less of the OCV value upon the completion of charge is input, the detection result is output to the control means. The third control means outputs a control signal to the thickness detection means 11 and the cycle number detection means 12, thereby causing them to detect the thickness of the electrode assembly and the number of charge and discharge cycles. Also, after the number of charge and discharge cycles which can be applied before the battery 10 needs to be replaced has been determined, the third control means outputs a control signal to the replacement time indication means 14, thereby causing it to display the determined number of charge and discharge cycles.

The third storage means, the third computation means, and the third control means comprise a processing circuit including a micro computer, an interface, memory, a timer, etc., just like the first to second storage means, the first to second computation means, and the first to second control means. Various memories can be used as the third storage means, just like the first to second storage means.

In this embodiment, the storage means, the computation means, and the control means are independently provided for each of the thickness detection means 11, the cycle number detection means 12, and the first determination means 13. However, they may be integrated into one storage means, one computation means, and one control means. For example, a central processing unit (CPU) may be provided as a processing circuit including a micro computer, an interface, memory, a timer, etc.

### (5) Replacement Time Indication Means 14

The replacement time indication means 14 displays the number of charge and discharge cycles which can be applied before the battery 10 needs to be replaced. The number of charge and discharge cycles displayed decreases as the number of charge and discharge cycles of the battery 10 increases. Also, when the number of charge and discharge cycles which can be applied before the replacement time is less than, for example, 10 or 5, that number can be displayed in an eye-catching color such as red or in blinking characters. The replacement time indication means 14 can be, for example, a liquid crystal display or an indicator light.

Also, in this embodiment, the replacement time indication means 14 is used without limitation, and it is also possible to provide replacement time indication means which indicates the battery replacement time calculated by the first determination means 13 by sound. Further, it is also possible to provide charge and discharge control means which stops the charge and discharge of the battery 10 according to the battery replacement time calculated by the first determination means 13. The function of the charge and discharge control means may be added to the first determination means 13.

Next, referring to FIG. 3, the determination operation of the battery pack 1 of the invention is described.

In step S1, the voltage detection means included in the thickness detection means 11 or the cycle number detection means 12 detects the OCV value of the battery 10 immediately after charge, and further, detects the OCV value of the battery 10 at a regular interval. In step S2, the cycle number detection means 12 determines whether or not the detection result by the voltage detection means is 50% or less of the OCV value of the battery 10 immediately after charge. When it is 50% or less, proceed to step S3. When it is not 50% or less, return to step S1.

In step S3, a determination result that the detection result by the voltage detection means is 50% or less of the OCV value of the battery 10 immediately after charge is input into the first control means of the thickness detection means 11. The first control means outputs a control signal to the pressure detection means, thereby causing the pressure detection means to detect the inner pressure of the electrode assembly 20. The thickness detection means 11 makes a computation based on the detection result of the inner pressure of the electrode assembly 20 by the pressure detection means to detect the thickness of the electrode assembly 20. The detection result of the thickness of the electrode assembly 20 is input into the first determination means 13.

In step S4, the first control means of the thickness detection means 11 outputs a control signal to the second control means of the cycle number detection means 12 simultaneously with the output of the control signal to the pressure detection means of the thickness detection means 11. As a result, the number of charge and discharge cycles upon the detection of the thickness of the electrode assembly 20 by the thickness detection means 11 is detected. The detection result of the number of charge and discharge cycles is input into the first determination means 13.

In step S5, the first determination means 13 determines whether or not the detection result of the thickness of the electrode assembly 20 by the thickness detection means 11 is equal to the smallest thickness of the electrode assembly 20 (whether or not it is larger than the smallest thickness of the electrode assembly 20). When it is equal, proceed to step S6. When it is not equal, return to step S1. In step S6, the first determination means 13 calculates the number of charge and discharge cycles which can be applied before battery replacement time from the detection result of the thickness of the electrode assembly 20 by the thickness detection means 11 and the detection result of the number of charge and discharge cycles by the cycle number detection means 12.

In step S7, the number of charge and discharge cycles that can be applied before battery replacement time, calculated in step S6, is displayed by the replacement time indication means 14. In this way, the operation of the battery pack 1 of the invention for determining the number of charge and discharge cycles which can be applied before battery replacement time is completed.

### Second Embodiment

FIG. 5 is a block diagram schematically showing the configuration of a battery pack 2 in a second embodiment of the invention. The battery pack 2 is similar to the battery pack 1, and corresponding components are given the same reference characters with their descriptions omitted. The battery pack 2 is characterized by including first determination means 13a in place of the first determination means 13 and not including the cycle number detection means 12. The other features are the same as those of the battery pack 1.

The first determination means 13a has cycle number detection means different from the cycle number detection means 12, in addition to the first determination means 13. This cycle number detection means detects the application of a charge voltage to the battery 10 for a certain time or more, and counts such voltage application as one charge and discharge cycle. Also, since the battery pack 2 has no voltage detection means, it cannot determine the number of the electrode assemblies 20 laminated or the number of times the electrode assembly 20 is wound, unlike the battery pack 1. Thus, the first determination means 13a is configured so that the number of the electrode assemblies 20 laminated or the number of times the electrode assembly 20 is wound can be input thereinto from outside.

Specifically, for example, the battery pack 2 is equipped with a USB input terminal (not shown). By connecting the battery pack 2 with a personal computer via a USB cable, the number of the electrode assemblies 20 laminated or the number of times the electrode assembly 20 is wound can be input into the first determination means 13a. The number of the electrode assemblies 20 laminated or the number of times the electrode assembly 20 is wound is indicated on the battery 10. Also, the manual of the battery pack 2 clearly shows the specifications of the battery 10 suited for the battery pack 2. Hence, the user can easily select the battery 10 suited for the battery pack 2. The battery pack 2 also can almost accurately calculate the number of charge and discharge cycles which can be applied before battery replacement after the thickness of the electrode assembly 20 has becomes smallest, in the same manner as the battery pack 1.

### Third Embodiment

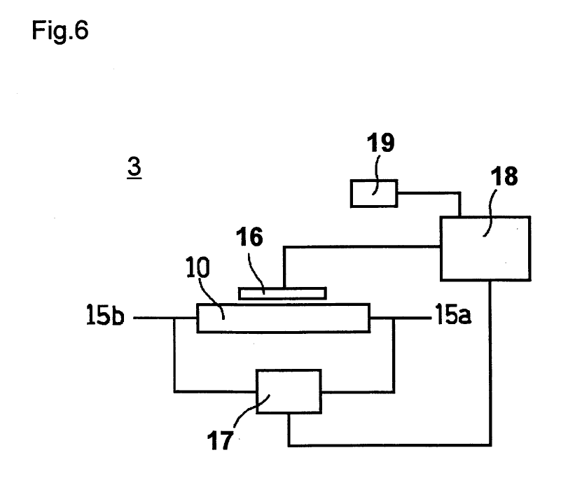

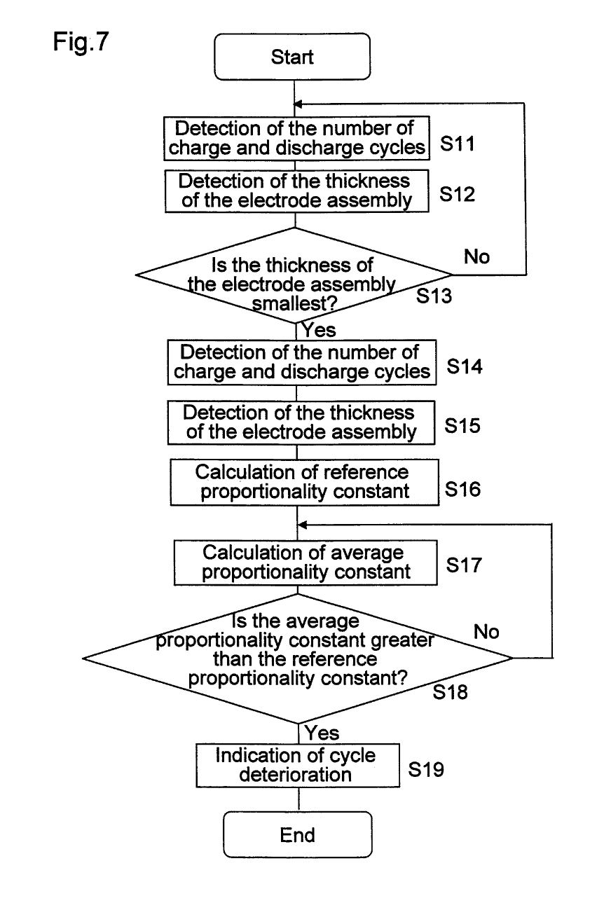

FIG. 6 is a block diagram schematically showing the configuration of a battery pack 3 in a third embodiment of the invention. FIG. 7 is a flow chart showing one embodiment of a method for determining cycle deterioration of the non-aqueous electrolyte secondary battery 10 illustrated in FIG. 2.

The present inventors have found, as described above, that the swelling characteristics of alloy-type secondary batteries are different from those of conventional non-aqueous electrolyte secondary batteries including graphite (hereinafter referred to as “conventional batteries”). Battery swelling occurs mainly due to swelling of the electrode assembly included in the battery case. In conventional batteries, as the number of charge and discharge cycles increases, the electrode assembly gradually swells.

In contrast, the present inventors have found that alloy-type secondary batteries have swelling characteristics as shown in FIG. 4. That is, in an early stage of use, the thickness of the electrode assembly gradually decreases, and after the thickness of the electrode assembly has become smallest, the thickness of the electrode assembly gradually increases. Further, the present inventors have found that after the thickness of the electrode assembly has started to increase, there is a correlation (a proportional relationship with a predetermined proportionality constant) between the number of charge and discharge cycles and the thickness of the electrode assembly. However, based on only this correlation, it is not possible to determine the presence or absence of sudden cycle deterioration.

The present inventors have conducted further studies on the correlation between the number of charge and discharge cycles of alloy-type secondary batteries and the thickness of the electrode assembly. As a result, they have found that in alloy-type secondary batteries which suddenly exhibit significant cycle deterioration, the rate of increase of the thickness of the electrode assembly changes sharply before such cycle deterioration occurs. That is, they have found that there is a proportional relationship between the number of charge and discharge cycles and the thickness of the electrode assembly, and that the proportionality constant in the proportional relationship changes and increases before significant cycle deterioration occurs suddenly.

Based on this finding, the present inventors have arrived at a configuration for determining the presence or absence of cycle deterioration before significant cycle deterioration occurs suddenly, based on the change in the correlation between the number of charge and discharge cycles and the thickness of the electrode assembly. They have found that according to this configuration, the presence or absence of cycle deterioration can be determined almost accurately before significant cycle deterioration occurs suddenly.

According to the invention, the presence or absence of significant cycle deterioration of alloy-type secondary batteries can be determined almost accurately. More specifically, before significant cycle deterioration of such a battery occurs suddenly, the start of significant cycle deterioration of the battery can be detected. As a result, it is possible to predict significant cycle deterioration and concomitant large battery swelling and replace the battery pack. Therefore, in various electronic devices and electric vehicles powered by the above-mentioned battery pack, such problems as loss of data produced and shutdown of the drive motor while driving can be prevented. Also, even if there is a possibility that the battery can swell significantly due to some factor, such large swelling can be prevented with high reliability.

The battery pack 3 of this embodiment includes a non-aqueous electrolyte secondary battery including an alloyable active material and a mechanism for carrying out a method for determining the presence or absence of cycle deterioration of the non-aqueous electrolyte secondary battery. Thus, before significant cycle deterioration occurs suddenly, the battery pack 3 can be replaced. The battery pack 3 of this embodiment has a high long-term reliability, and is effective as the power source for various electronic devices, the main power source or auxiliary power source for electric vehicles, etc.

The battery pack 3 includes: the battery 10; thickness detection means 16 which detects the thickness of the electrode assembly 20 included in the battery 10; cycle number detection means 17 which detects the number of charge and discharge cycles of the battery 10; second determination means 18 which determines the presence or absence of cycle deterioration of the battery 10 from the detection result by the thickness detection means 16 and the detection result by the cycle number detection means 17; cycle deterioration indication means 19 which displays a determination result by the second determination means 18 that cycle deterioration has occurred; external connection terminals 15a and 15b connected to the connection terminals of an external terminal; and a housing (not shown).

In this embodiment, the battery 10, the thickness detection means 16, the cycle number detection means 17, and the second determination means 18 are contained in the housing. The cycle deterioration indication means 19 is disposed so as to be exposed at the surface of the housing. Also, the external connection terminals 15a and 15b are mounted in predetermined positions of the housing. The battery 10 is the battery 10 illustrated in FIG. 2.

### (1) Thickness Detection Means 16

The thickness detection means 16 detects the thickness information of the electrode assembly 20 included in the battery 10. In this embodiment, the thickness detection means 16 detects the inner pressure of the electrode assembly 20 as the thickness information of the electrode assembly 20, and calculates the thickness of the electrode assembly 20 from the detection result. The thickness detection means 16 outputs the calculation result to the second determination means 18. The thickness detection means 16 and the second determination means 18 are connected so that information is exchangeable therebetween, for example, by electrical connection or optical connection. Information exchangeable connection refers to connection which allows detection results, control signals, and the like to be input and output.

The thickness detection means 16 in this embodiment includes a pressure sensor, fourth storage means, fourth computation means, and fourth control means (which are not shown), and at least the pressure sensor is disposed near the non-aqueous electrolyte secondary battery 10. The pressure sensor, the fourth storage means, the fourth computation means, and the fourth control means are connected so that information is exchangeable therebetween.

The pressure sensor detects the inner pressure of the electrode assembly 20. In this embodiment, since the electrode assembly 20 is a laminated one with a flat shape, the inner pressure thereof can be detected accurately by using the pressure sensor. In terms of detecting the inner pressure with the pressure sensor accurately, a flat electrode assembly can be used instead of the electrode assembly 20.

It is preferable to bring the pressure sensor into contact with the central part of the flat portion of the battery 10. In this case, the inner pressure of the electrode assembly 20 can be detected more accurately. The flat portion of the battery 10 refers to the outer surface of the battery case 27 corresponding to the surface of the electrode assembly 20 in the thickness direction thereof. The central part of the flat portion refers to the position of the outer surface of the battery case 27 corresponding to the center of the surface of the electrode assembly 20 in the thickness direction thereof.

The electrode assembly 20 is a laminated one, and its surface in the thickness direction has a quadrangular shape such as a rectangle or a square when seen from vertically above. The point of intersection of the diagonal lines of the quadrangle is the center of the surface of the electrode assembly 20 in the thickness direction. The central part of the battery 10 does not need to accurately agree with the center of the electrode assembly 20, and the inner pressure of the electrode assembly 20 can also be detected almost accurately in the vicinity of the center of the electrode assembly 20. The vicinity of the center of the electrode assembly 20 refers to a circular area within a radius of approximately 5 mm to 10 mm from the center of the electrode assembly 20. Since the shape of a flat electrode assembly when seen from vertically above is quadrangular in the same manner as the laminated electrode assembly 20, its center can be defined in the same manner as the center of the electrode assembly 20.

The pressure sensor detects the inner pressure of the electrode assembly 20 immediately after the cycle number detection means 17 has updated the number of charge and discharge cycles. The thickness of the electrode assembly 20 can be estimated almost accurately from the inner pressure of the electrode assembly 20. The update of the number of charge and discharge cycles by the cycle number detection means 17 will be explained in the description of the cycle number detection means 17 given below.

While the pressure sensor can be any conventional pressure sensor, it is preferably a small pressure sensor such as HSPC series (trade name; available from ALPS ELECTRIC CO., LTD.) or PS-A pressure sensor (trade name; available from Panasonic Electric Works Co., Ltd.). The pressure sensor outputs the detection result to the fourth storage means.

The detection result by the pressure sensor is input into the fourth storage means. This detection result is rewritten every time a new detection result is input. Based on this detection result, the thickness of the electrode assembly 20 is calculated, and is input into the fourth storage means. The fourth storage means stores a sixth data table showing the relationship between the inner pressure of the electrode assembly 20 in a fully charged state and the thickness of the electrode assembly 20.

The relationship between the inner pressure of the electrode assembly 20 in a fully charged state and the thickness changes depending on the number of electrode units laminated, the initial thickness of the electrode assembly 20, the initial thickness of the negative electrode active material layer 22b, etc. Thus, the sixth data table shows the relationship between the inner pressure of the electrode assembly 20 in a fully charged state and the thickness of the electrode assembly 20 in predetermined specifications (the number of electrode units laminated, the initial thickness of the electrode assembly 20, and the initial thickness of the negative electrode active material layer 22b). The sixth data table is prepared by experiments in advance.

An electrode unit is composed of a positive electrode 21, a negative electrode 22, and a separator 23 interposed therebetween. By interposing one separator 23 between a pair of adjacent electrode units, a laminated electrode assembly comprising a laminate of the electrode units can be produced. In this embodiment, the number of the electrode assemblies 20 laminated refers to the number of electrode units laminated. In the battery 10 illustrated in FIG. 2, the number of the electrode assemblies 20 laminated is one.

In the electrode assembly 20 including an alloyable active material, there is a relation represented by the formula (1): Y=αX+T₀ (wherein α represents the proportionality constant) between the inner pressure X of the electrode assembly 20 in a fully charged state, the thickness Y of the electrode assembly 20, and the initial thickness T₀ of the electrode assembly 20. Thus, the proportionality constant α in the formula (1) is determined according to the number of the electrode assemblies 20 laminated, and is input into the fourth storage means as the sixth data table.

In this case, the number of the electrode assemblies 20 laminated may be set continuously like 1, 2, 3 . . . , but it is preferable to set the number of the electrode assemblies 20 laminated in stages, for example, 1 to 5, 6 to 10, 11 to 15 . . . , by setting numerical ranges, and determine the proportionality constant α for each numerical range. To determine the proportionality constant α_{1 to 5} for the numerical range of the lamination number from 1 to 5, the proportionality constants α₁ to α₅ for the respective lamination numbers of 1 to 5 are determined, and the average value thereof is used as the proportionality constant α_{1 to 5}. When the electrode assembly 20 is a flat electrode assembly, the proportionality constant α is determined in the same manner as in the case of the number of lamination except that the number of winding is used instead of the number of lamination.

Further, the fourth storage means stores a program which calculates the thickness of the electrode assembly 20 from the sixth data table based on the detection result by the pressure sensor. The thickness of the electrode assembly 20 can be calculated by the method as described above. This program is carried out by the fourth computation means.

The fourth computation means calculates the thickness of the electrode assembly 20 based on the detection result by the pressure sensor (the inner pressure value of the electrode assembly 20), the number of the electrode assemblies 20 laminated, and the sixth data table. Since the number of the electrode assemblies 20 laminated is determined when the battery pack 3 is designed, it is stored in the fourth storage means in advance together with the sixth data table.

Every time a new detection result by the pressure sensor is input into the fourth storage means, the fourth computation means retrieves the detection result and the sixth data table from the fourth storage means, and calculates the thickness of the electrode assembly 20. The fourth computation means outputs the calculation result to the fourth storage means.

The fourth control means controls the pressure sensor and the fourth computation means according to a control signal indicating that the number of charge and discharge cycles has been updated by the cycle number detection means 17. More specifically, the fourth control means controls the detection of the inner pressure of the electrode assembly 20 by the pressure sensor and the calculation of the thickness of the electrode assembly 20 by the fourth computation means when the battery 10 is fully charged. The fourth control means retrieves the calculation result by the fourth computation means from the fourth storage means, and outputs it to the second determination means 18.

In this embodiment, the fourth storage means, the fourth computation means, and the fourth control means comprise a processing circuit including a micro computer, an interface, memory, a timer, etc. Various memories commonly used in this field can be used as the fourth storage means, and examples include read only memory (ROM), random access memory (RAM), semiconductor memory, and nonvolatile flash memory. Instead of the fourth storage means, the fourth computation means, and the fourth control means, it is also possible to use an external device in which the battery pack 3 is to be mounted, the CPU (central information processing unit) of the second determination means 18, or the like.

### (2) Cycle Number Detection Means 17

The cycle number detection means 17 detects the number of charge and discharge cycles of the battery 10. In this embodiment, a charge and discharge cycle is defined as a cycle in which the fully charged battery 10 is discharged, becomes a fully discharged state, charged, and becomes a fully charged state again. In a fully charged state, the SOC is preferably 90% or more. The cycle number detection means 17 is connected to the second determination means 18 so that information is exchangeable through electrical signals. The cycle number detection means 17 outputs the detection result to the second determination means 18.

The cycle number detection means 17 of this embodiment includes voltage detection means, fifth storage means, fifth computation means, and fifth control means, which are not shown.

The voltage detection means is controlled by the fifth control means so that it detects the open circuit voltage (hereinafter “OCV”) of the battery 10 at a predetermined interval of time.

The OCV value of the battery 10 has the following characteristics. Upon the start of a charge of the battery 10, the OCV value becomes lowest. Thereafter, due to the charge, the OCV value increases stably and reaches a maximum. After the completion of the charge, due to a discharge, the OCV value gradually lowers and reaches the lowest value. The cycle of the OCV value from a maximum, then a decrease, up to the next maximum is one charge and discharge cycle. By detecting the OCV value of the battery 10 over time, the number of charge and discharge cycles of the battery 10 can be accurately detected.

The OCV detection by the voltage detection means can be performed, for example, at an interval of 0.1 second to 1000 seconds, preferably 1 second to 60 seconds. The voltage detection means can be, for example, a voltmeter. The detection results by the voltage detection means over time are input into the fifth storage means.

The number of charge and discharge cycles is input into the fifth storage means as well as the detection results by the voltage detection means. The number of charge and discharge cycles is rewritten every time a new numerical value is input.

When the detection result by the voltage detection means is input into the fifth storage means, the fifth computation means retrieves the detection result, and counts the cycle of the detected OCV value from a maximum to the next maximum as one charge and discharge cycle. When the fifth computation means acknowledges that one charge and discharge cycle has been completed, it adds “one” to the number of charge and discharge cycles stored in the fifth storage means, and outputs the resulting new value to the fifth storage means.

The fifth control means controls the OCV value detection by the voltage detection means. Also, when the number of charge and discharge cycles stored in the fifth storage means is rewritten to a new value, the fifth control means outputs the new value to the second determination means 18.

In this embodiment, the fifth storage means, the fifth computation means, and the fifth control means comprise a processing circuit including a micro computer, an interface, memory, a timer, etc. Various memories commonly used in this field can be used as the fifth storage means, and examples include read only memory, random access memory, semiconductor memory, and nonvolatile flash memory. Instead of the fifth storage means, the fifth computation means, and the fifth control means, it is also possible to use the CPU (central information processing unit) of an external device into which the battery pack 3 is to be mounted, or the like.

In this embodiment, the detection of the number of charge and discharge cycles is performed by detecting the OCV value, but is not limited thereto. For example, the closed circuit terminal voltage (CCV) may be detected to detect the number of charge and discharge cycles. In the case of CCV detection, it is preferable to lower the current rate measured. Specifically, the current rate measured is preferably 0.2 C or less. In this case, the CCV value detected is unlikely to be affected by the current rate, and more accurate detection becomes possible. The current rate can be controlled by the fifth control means.

CCV detection may be affected by ambient temperature. Specifically, when the ambient temperature is lower than 20° C., even if the current rate is made 0.2 C or less, the CCV value detected may be inaccurate. Thus, it is desirable to perform CCV detection while detecting the temperature of the battery 10 by using temperature detection means. The relationship between the temperature of the battery 10, the current rate, and the CCV value is determined by experiments in advance, and is input into the fifth storage means as a seventh data table. The fifth computation means corrects the detected CCV value based on the seventh data table, the current rate, and the detected temperature to obtain a correct CCV value. The temperature detection means can be a commercially available, small temperature sensor for use in temperature detection for electronic devices, semiconductor products, etc.

CCV detection may be affected by discharge depth. Specifically, when the discharge depth is different in CCV detection, even if the current rate is made 0.2 C or less, the detected CCV value may vary, and the number of charge and discharge cycles may not be detected accurately. Hence, it is desirable to perform CCV detection while detecting discharge depth. The relationship between the discharge depth, the current rate, and the CCV value is determined by experiments in advance, and is input into the fifth storage means as an eighth data table. The fifth computation means corrects the detected CCV value based on the eighth data table, the current rate, and the discharge depth to obtain a correct CCV value.

The discharge depth can be calculated from the rated capacity of the battery 10 and the amount of electricity discharged. The amount of electricity discharged can be calculated as a total obtained by multiplying the discharge current by the discharge time value, after completion of one charge and discharge cycle. A program for calculating discharge depth is input into the fifth storage means in advance.

Also, the discharge depth may be kept constant to perform CCV detection.

### (3) Second Determination Means 18

The second determination means 18 determines the presence or absence of cycle deterioration according to the detection result by the thickness detection means 16 (the thickness of the electrode assembly 20) and the detection result by the cycle number detection means 17 (the number of charge and discharge cycles). More specifically, the second determination means 18 determines the correlation between the thickness of the electrode assembly 20 and the number of charge and discharge cycles from the detection result by the thickness detection means 16 and the detection result by the cycle number detection means 17, and detects the change in the correlation to determine the presence or absence of cycle deterioration.

The present inventors have found that the battery 10 has a correlation between the thickness of the electrode assembly 20 and the number of charge and discharge cycles which is different from that of conventional batteries. Based on FIG. 4, the correlation between the thickness of the electrode assembly 20 and the number of charge and discharge cycles is more specifically described.

As shown in FIG. 4, at N₀ at which the number of charge and discharge cycles is zero, the electrode assembly 20 has the initial thickness t₀. As the number of charge and discharge cycles increases, the thickness of the electrode assembly 20 gradually decreases, and at N₁, the thickness of the electrode assembly 20 becomes smallest. From N₀ to N₁, the thickness of the electrode assembly 20 and the number of charge and discharge cycles have a negatively proportional relationship or an inversely proportional relationship. As the number of charge and discharge cycles increases from N₁, the thickness of the electrode assembly 20 also gradually increases. After N₁, the thickness of the electrode assembly 20 and the number of charge and discharge cycles have a positively proportional relationship.

In batteries which exhibit significant cycle deterioration, the proportionality constant in the proportional relationship between the thickness of the electrode assembly 20 and the number of charge and discharge cycles after N₂, at which the number of charge and discharge cycles is larger than that at N₁, is increased relative to the proportionality constant from N₁ to N₂. Such change of increase in the proportionality constant occurs immediately before significant cycle deterioration occurs. Therefore, by detecting the change of increase in the proportionality constant, the presence or absence of significant cycle deterioration can be determined almost accurately. The change of increase in the proportionality constant is a phenomenon characteristic of the battery 10 including an alloyable active material.

Although the reason for the occurrence of such phenomenon in the battery 10 including an alloyable active material is not yet clear, it is probably because the shape of the alloyable active material particles in the negative electrode active material layer 22b is optimized by the expansion and contraction caused by repeated charge and discharge cycles. The optimization of particle shape means that due to a change in particle shape, the volume of the gaps between the particles becomes smallest so the volume of the negative electrode active material layer 22b comprising the particles becomes smallest. This is probably the reason why the thickness of the electrode assembly 20 becomes smallest after a predetermined number of charge and discharge cycles.

After the optimization of particle shape, it is presumed that the thickness of the electrode assembly 20 gradually increases due to gradual swelling of the negative electrode active material layer 22b. In batteries which suddenly exhibit significant cycle deterioration, it is presumed that inside the negative electrode active material layer 22b, a large amount of byproducts are produced in the reaction between the alloyable active material and the non-aqueous electrolyte. As a result, it is presumed that the rate of swelling of the negative electrode active material layer 22b increases, thereby causing the change of increase in the proportionality constant at N₂. The present inventors have found that such byproducts are a cause of cycle deterioration.

The number of charge and discharge cycles at N₁ and N₂ changes depending on various features such as the number of the electrode assemblies 20 laminated (the number of winding in the case of a flat electrode assembly), the kind of the alloyable active material, the thickness of the negative electrode active material layer 22b, and the material of the negative electrode current collector 22a. However, even when any feature is employed, in the process of gradual increase in the thickness of the electrode assembly 20, there is always a change of increase in the proportionality constant in the proportional relationship between the thickness of the electrode assembly 20 and the number of charge and discharge cycles.

FIG. 4 shows that the thickness of the electrode assembly 20 gradually increases after N₁. However, the increase in the thickness of the electrode assembly 20 up to N₂ is in the order of microns, and such increase does not impair the performance of the battery 10, the user's safety, and the like.

The second determination means 18 includes sixth storage means, sixth computation means, and sixth control means.

The detection result by the thickness detection means 16 (the thickness of the electrode assembly 20) and the detection result by the cycle number detection means 17 (the number of charge and discharge cycles) are input into the sixth storage means.

The sixth storage means stores a program which determines the proportionality constant in the relationship between the thickness of the electrode assembly 20 and the number of charge and discharge cycles from the detection result by the thickness detection means 16 and the detection result by the cycle number detection means 17.

An example of a program which determines the proportionality constant is described. After 50 charge and discharge cycles from N₁, the detection results by the thickness detection means 16 for the 50 charge and discharge cycles and the detection results by the cycle number detection means 17 for the 50 charge and discharge cycles are plotted, and the proportionality constant (reference proportionality constant) is determined by the least-squares method. The determined reference proportionality constant is input into the sixth storage means. The number of charge and discharge cycles performed to determine the reference proportionality constant can be selected as appropriate, for example, from 5 to 200, preferably 10 to 100.

After the reference proportionality constant is determined, the average proportionality constant is determined for every five charge and discharge cycles. At this time, the average proportionality constant for the latest charge and discharge cycle and the preceding four charge and discharge cycles is determined. This average proportionality constant is updated every time another charge and discharge cycle is completed. In this embodiment, when the average proportionality constant has exceeded the reference proportionality constant by 1 to 3%, preferably 1 to 2%, a determination that N₂ has been reached is made. The ratio of the average proportionality constant to the reference proportionality constant is selected, for example, according to the number of electrode units laminated, the thickness of the negative electrode active material layer 22b, the kind of the alloyable active material, etc.

The sixth storage means also stores an N₁ determination program which determines N₁ at which the thickness of the electrode assembly 20 changes from decrease to increase. The previous thickness of the electrode assembly 20 is compared with the newly detected thickness of the electrode assembly 20. When the newly detected thickness of the electrode assembly 20 has become larger than the previous thickness of the electrode assembly 20, the number of charge and discharge cycles at which the previous thickness of the electrode assembly 20 was detected is determined as N₁. Upon the determination of N₁ by the N₁ determination program, the program which determines the proportionality constant is actuated. Further, the third storage means stores a program which controls the operation of the thickness detection means 16 according to the detection result by the cycle number detection means 17.

The sixth computation means determines the presence or absence of cycle deterioration by performing a computation based on the detection result by the thickness detection means 16, the detection result by the cycle number detection means 17, and the above-mentioned various programs, which are stored in the sixth storage means.

The sixth control means controls the detection of the thickness of the electrode assembly 20 by the thickness detection means 16 according to the detection result by the cycle number detection means 17. The sixth control means outputs a control signal to the cycle deterioration indication means 19 according to a determination by the sixth computation means that cycle deterioration has occurred, thereby causing the cycle deterioration indication means 19 to indicate to the user of the device that significant cycle deterioration will occur.

The sixth storage means, the sixth computation means, and the sixth control means comprise a processing circuit including a micro computer, an interface, memory, a timer, a CPU, etc. Various memories can be used as the sixth storage means, just like the fourth to fifth storage means. Instead of the sixth storage means, the sixth computation means, and the sixth control means, it is also possible to use the CPU of an external device powered by the battery pack 3.

In this embodiment, the storage means, the computation means, the control means, and the like are independently provided for each of the thickness detection means 16, the cycle number detection means 17, and the second determination means 18. However, they may be integrated into one storage means, one computation means, and one control means. For example, a central processing unit (CPU) may be provided as a processing circuit including a micro computer, an interface, memory, a timer, etc.

In a more preferable embodiment, the battery pack 3 can further include charge and discharge control means which stops the charge and discharge of the battery 10 according to a determination result by the second determination means 18 that cycle deterioration has occurred. Also, the function of the charge and discharge control means can be added to the second determination means 18.

### (4) Cycle Deterioration Indication Means 19

Upon receiving the control signal from the second determination means 18, the cycle deterioration indication means 19 indicates to the user that cycle deterioration has occurred. The cycle deterioration indication means 19 makes an indication by displaying or sound. The cycle deterioration indication means 19 can be, for example, a liquid crystal display, a lamp, or a voice generator. In this way, the user of the device can be reliably informed that significant cycle deterioration will occur soon.

The battery pack 3 may include second replacement time determination means. According to a determination result by the second determination means 18 that cycle deterioration has occurred, the second replacement time determination means determines the replacement time of the battery 10 from the detection result by the thickness detection means 16 and the detection result by the cycle number detection means 17 used to obtain this determination result. The second determination means 18 capable of controlling charge and discharge or the second replacement time determination means can prevent loss of data produced due to sudden occurrence of significant cycle deterioration, and the like.

The second replacement time determination means estimates the number of charge and discharge cycles which can be applied before significant cycle deterioration occurs from a ninth data table prepared by experiments in advance, for example, based on the thickness of the electrode assembly 20 and the number of charge and discharge cycles upon the determination that significant cycle deterioration will occur, and determines the replacement time.

Parameters of the ninth data table other than the thickness of the electrode assembly 20 and the number of charge and discharge cycles include the reference proportionality constant, the ratio of the average proportionality constant to the reference proportionality constant upon the previous determination, and the number of the electrode assemblies 20 laminated (the number of winding in the case of a wound electrode assembly or flat electrode assembly). Experiments are conducted by changing the numerical values of these parameters, in order to prepare the ninth data table showing the number of charge and discharge cycles which can be applied to batteries with significant cycle deterioration.

In the ninth data table, the number of the electrode assemblies 20 laminated (or the number of winding) is preferably set in stages, for example, 1 to 5, 6 to 10, and 11 to 15. The number of the electrode assemblies 20 laminated (or the number of winding) can be input, for example, from the terminals of a computer by providing the battery pack 3 with connection terminals for the computer. The ninth data table is input, for example, into the sixth storage means of the second determination means 18, so that the sixth computation means can determine the replacement time.

Next, referring to FIG. 7, the operation of the battery pack 3 of the invention to determine cycle deterioration is more specifically described.

In step S11, the cycle number detection means 17 detects the OCV value of the battery 10. It counts the cycle of the OCV value from a maximum to the next maximum due to discharge and charge as one charge and discharge cycle, adds “1” to the previously detected number of charge and discharge cycles, and outputs it to the second determination means 18. Upon receiving the new number of charge and discharge cycles, the second determination means 18 outputs a control signal to the thickness detection means 16. As a result, the thickness detection means 16 starts the operation of detecting the thickness of the electrode assembly 20.

In step S12, the thickness detection means 16 detects the thickness of the electrode assembly 20, and outputs the detection result to the second determination means 18.

In step S13, the second determination means 18 compares the thickness of the electrode assembly 20 obtained in step S12 (hereinafter “the thickness of step S12”) with the previous thickness of the electrode assembly 20 (hereinafter “the previous thickness”). When the thickness of step S12 is larger than the previous thickness, a determination that “Yes: having passed N₁ at which the thickness of the electrode assembly 20 is smallest” is made, and proceed to step S14. When the thickness of step S12 is smaller than the previous thickness, a determination that “No: not having passed N₁ yet” is made, and return to step S11. At this time, the previous thickness is rewritten to the thickness of step S12.

In step S14, the cycle number detection means 17 updates the number of charge and discharge cycles, and outputs the updated value to the second determination means 18, in the same manner as in step S11. In step S15, the cycle number detection means 17 detects the thickness of the electrode assembly 20, and outputs the detection result to the second determination means 18, in the same manner as in step S12.

In step S16, the second determination means 18 plots the thicknesses of the electrode assembly 20 for 50 charge and discharge cycles after N₁, with the number of charge and discharge cycles as abscissa and the thickness of the electrode assembly 20 as ordinate, and determines the reference proportionality constant by the least-squares method. The reference proportionality constant is input into the sixth storage means of the second determination means 18.

In step S17, the second determination means 18 determines the average proportionality constant for five charge and discharge cycles after having determined the reference proportionality constant. Every time the number of charge and discharge cycles is updated by the cycle number detection means 17, the average proportionality constant is determined from the thicknesses of the electrode assembly 20 detected in the preceding four charge and discharge cycles and the thickness of the electrode assembly 20 detected in the latest charge and discharge cycle. The average proportionality constant can be obtained in the same manner as the reference proportionality constant. The average proportionality constant is input into the sixth storage means of the second determination means 18.

In step S18, the second determination means 18 compares the reference proportionality constant with the average proportionality constant. When the ratio of the average proportionality constant to the reference proportionality constant has exceeded by 1 to 3%, preferably by 1 to 2%, a determination that “Yes: significant cycle deterioration has occurred” is made, and proceed to step S19. When the ratio of the average proportionality constant to the reference proportionality constant has exceeded by less than 1%, a determination that “No: there is no significant cycle deterioration” is made, and return to step S17. It should be noted that the above-mentioned ratio of the average proportionality constant to the reference proportionality constant are the values when the number of the electrode assemblies 20 laminated is one. The ratio of the average proportionality constant to the reference proportionality constant can be selected as appropriate, depending on the number of the electrode assemblies 20 laminated and the like. The ratio can be determined by experiments in advance.

In step S19, according to the determination result by the second determination means 18 that significant cycle deterioration has occurred, the determination result is displayed on the surface of the battery pack 3 or the surface of the external device powered by the battery pack 3. In this way, the series of operations for determining cycle deterioration are completed.

The battery pack 3 of this embodiment can be produced by connecting the battery 10, the thickness detection means 16, the cycle number detection means 17, and the second determination means 18, placing them into a housing with the cycle deterioration indication means 19 on the surface and the external connection terminals 15a and 15b at both ends in the longitudinal direction, and sealing them.

In this embodiment, the presence or absence of sudden significant cycle deterioration is determined by calculating the thickness of the electrode assembly 20 from the inner pressure value of the electrode assembly 20 and determining the relationship between the number of charge and discharge cycles and the electrode assembly 20. The invention is not limited to this method, and the presence or absence of sudden significant cycle deterioration may be determined, for example, from the inner pressure value of the electrode assembly 20. That is, in another embodiment, the presence or absence of sudden significant cycle deterioration can be determined without calculating the thickness of the electrode assembly 20 from the detection result by the pressure sensor.

The number of charge and discharge cycles and the inner pressure of the electrode assembly 20 have a proportional relationship in the same manner as the number of charge and discharge cycles and the thickness of the electrode assembly 20. That is, in the graph shown in FIG. 4, after the thickness of the electrode assembly 20 has become smallest, the number of charge and discharge cycles and the inner pressure of the electrode assembly 20 have a positively proportional relationship. The proportionality constant in the proportional relationship increases immediately before significant cycle deterioration occurs suddenly. Based on this relationship, the presence or absence of sudden significant cycle deterioration can be determined.

Determination based on the detection of the inner pressure of the electrode assembly 20 has an advantage in that the presence or absence of sudden significant cycle deterioration can be determined more accurately. For example, when the battery case 27 is made of a metal and thin, the swelling of the electrode assembly 20 may be suppressed by the battery case 27. At this time, the electrode assembly 20 is under pressure. When the swelling of the electrode assembly 20 is suppressed, measured values of the inner pressure of the electrode assembly 20 may be different from the actual values.

Thus, under a condition where the swelling of the electrode assembly 20 is not suppressed, the relationship between the number of charge and discharge cycles and the inner pressure of the electrode assembly 20 is measured to prepare a tenth data table. The tenth data table serves as a reference for determining deterioration. Also, while suppressing the swelling of the electrode assembly 20, the relationship between the number of charge and discharge cycles and the inner pressure of the electrode assembly 20 is measured to prepare an eleventh data table. In the preparation of the eleventh data table, the number of the electrode assemblies 20 laminated and the material and thickness of the battery case 27 are used as parameters. The tenth data table and the eleventh data table are stored in the sixth storage means of the second determination means 18 in advance.

The second determination means 18 determines whether or not the electrode assembly 20 is under pressure, from the tenth data table and the eleventh data table, based on the detection result by the cycle number detection means 17 (the number of charge and discharge cycles) and the detection result by the pressure sensor (the inner pressure value of the electrode assembly 20). This determination is made by the sixth computation means of the second determination means 18, and the sixth control means outputs a control signal according to the determination result by the sixth computation means, in the same manner as in the battery pack 3.

When the second determination means 18 determines that the electrode assembly 20 is under pressure, it corrects the inner pressure value based on the number of charge and discharge cycles and the eleventh data table, and determines the presence or absence of sudden significant cycle deterioration based on the tenth data table. When the second determination means 18 determines that the electrode assembly 20 is not under pressure, it determines the presence or absence of sudden significant cycle deterioration based on the tenth data table without correcting the inner pressure value. In this way, the presence or absence of sudden significant cycle deterioration can be determined more accurately without being affected by such parameters as the number of the electrode assemblies 20 laminated and the material and thickness of the battery case 27.

In this embodiment, the operation of the second determination means 18 to determine the number N₁ of charge and discharge cycles at which the thickness of the electrode assembly 20 becomes smallest and the operation to determine the presence or absence of significant cycle deterioration from the reference proportionality constant and the average proportionality constant are performed in the same manner as the operations shown in FIG. 7. That is, the number N₁ of charge and discharge cycles is determined from the number of charge and discharge cycles and the inner pressure of the electrode assembly 20. The presence or absence of significant cycle deterioration is determined by obtaining the reference proportionality constant and the average proportionality constant from the relationship between the number of charge and discharge cycles and the inner pressure of the electrode assembly 20 after the number N₁ of charge and discharge cycles and comparing them.

The battery pack of this embodiment has the same configuration as the battery pack 3 except that the second determination means 18 has the above-described configuration.

In the foregoing embodiments, the electrode assembly 20 is used, but it is not limited and may be a flat electrode assembly. A flat electrode assembly can be produced by winding a strip-like positive electrode, a strip-like negative electrode, and a strip-like insulating layer interposed therebetween to form a wound electrode assembly, and pressing the wound electrode assembly. A flat electrode assembly can also be produced by winding a strip-like positive electrode, a strip-like negative electrode, and a strip-like insulating layer interposed therebetween around a plate. The number of lamination of a flat electrode assembly is the number of winding thereof×2.

In the foregoing embodiments, the negative electrode active material layer 22b of the battery 10 is a thin film of an alloyable active material formed by a vapor deposition method, but it is not limited and may be, for example, a thin film including a plurality of columns. The columns include an alloyable active material and extend outwardly from the surface of the negative electrode current collector. The columns are preferably formed so that they extend in the same direction. Also, there is a gap between a pair of adjacent columns. The thin film including the columns has good adhesion to the negative electrode active material layer. The columns are preferably formed on the surfaces of a plurality of protrusions formed on the surface of a negative electrode current collector.

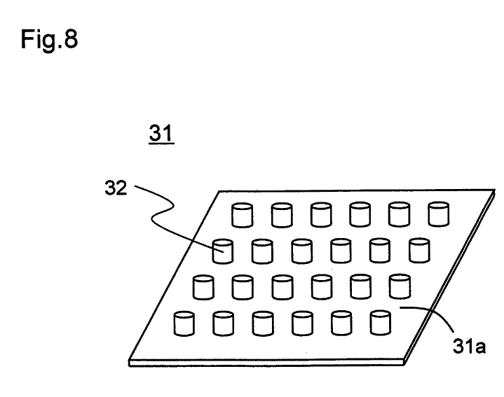

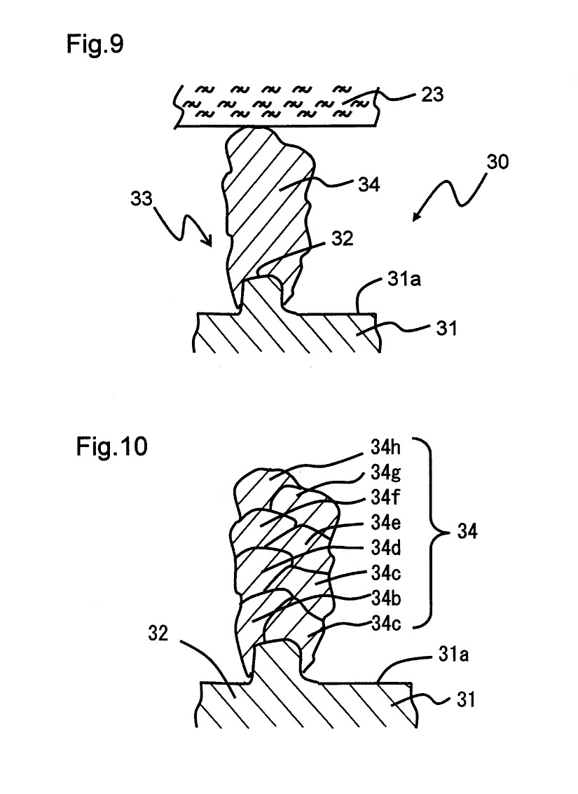

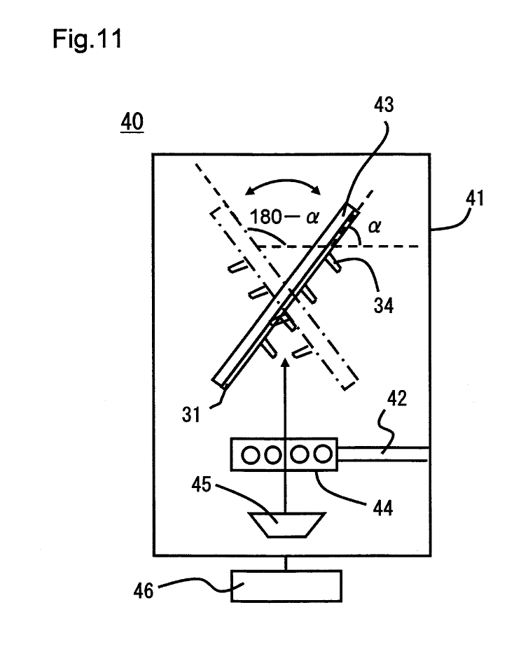

That is, the invention can use a negative electrode of another embodiment which includes a negative electrode current collector with a plurality of protrusions on the surface, and a negative electrode active material layer including a plurality of columns. FIG. 8 is a perspective view schematically showing the configuration of a negative electrode current collector 31 in another embodiment. FIG. 9 is a longitudinal sectional view schematically showing the configuration of a negative electrode 30 in another embodiment including the negative electrode current collector 31 of FIG. 8. FIG. 10 is a longitudinal sectional view schematically showing the configuration of a column 34 included in a negative electrode active material layer 33 of the negative electrode 30 illustrated in FIG. 9. FIG. 11 is a side view schematically showing the configuration of an electron beam deposition device 40.

The negative electrode 30 includes the negative electrode current collector 31 and the negative electrode active material layer 33.

As shown in FIG. 8, the negative electrode current collector 31 is characterized by having a plurality of protrusions 32 on a surface in the thickness direction, and has the same configuration as the negative electrode current collector 22a except for the protrusions 32. In the negative electrode current collector 31 of this embodiment, the protrusions 32 are formed on a surface in the thickness direction, but they are not limited and may be provided on both surfaces in the thickness direction.

The protrusions 32 are projections which extend outwardly from a surface 31a (hereinafter referred to as simply the “surface 31a ”) of the negative electrode current collector 31 in the thickness direction.

While the height of the protrusions 32 is not particularly limited, the average height is preferably about 3 to 10 μm. The height of the protrusions 32 is defined in a section of the protrusions 32 in the thickness direction of the negative electrode current collector 31. The section of the protrusions 32 refers to the section including the outermost point in the direction in which the protrusions 32 extend. In the section of each protrusion 32, the height of the protrusion 32 is the length of the vertical line from the outermost point in the extending direction of the protrusion 32 to the surface 31a. The average height of the protrusions 32 can be determined, for example, by observing a section of the negative electrode current collector 31 in the thickness direction with a scanning electron microscope (SEM), measuring the heights of, for example, 100 protrusions 32, and calculating the average value from the measured values.

While the sectional diameter of the protrusions 32 is not particularly limited, it is, for example, 1 to 50 μm. The sectional diameter of each protrusion 32 refers to the width of the protrusion 32 parallel to the surface 31a in the section of the protrusion 32 which is used to determine the height of the protrusion 32. The sectional diameter of the protrusions 32 can also be obtained in the same manner as the height of the protrusions 32 by measuring the widths of 100 protrusions 32 and calculating the average value of the measured values.

The protrusions 32 do not need to have the same height or the same sectional diameter.

The protrusions 32 have a circular shape in this embodiment. The shape of the protrusions 32 refers to the shape of the protrusions 32 in orthographic projection seen from vertically above when the negative electrode current collector 31 is disposed so that the surface 31a thereof is horizontal. The shape of the protrusions 32 is not limited to a circle, and may be, for example, a polygon, an oval, a parallelogram, a trapezoid, or a rhombus. In consideration of production costs, etc., the polygon is preferably a triangle to an octagon, and more preferably an equilateral triangle to an equilateral octagon.

Each of the protrusions 32 has an almost flat top face at the end in the extending direction. The flat top face of the protrusion 32 at the end increases the adhesion between the protrusion 32 and the column 34. It is more preferable, in terms of increasing bonding strength, that the top face at the end be substantially parallel to the surface 31a.

The number of the protrusions 32, the interval between the protrusions 32, and the like are not particularly limited and can be selected as appropriate, depending on the size (e.g., height and sectional diameter) of the protrusions 32, the size of the columns 34 formed on the surfaces of the protrusions 32, etc. The number of the protrusions 32 is, for example, approximately 10,000 to 10,000,000/cm². Also, the protrusions 32 are preferably formed so that the axis-to-axis distance of the adjacent protrusions 32 is approximately 2 to 100 μm. The protrusions 32 are arranged regularly or irregularly. Examples of regular arrangements include a houndstooth check pattern, a lattice pattern, and a close-packed pattern.

The surface of each protrusion 32 may be provided with a bump (not shown). In this case, for example, the adhesion between the protrusion 32 and the column 34 is further enhanced, thereby enabling more reliable prevention of the separation of the column 34 from the protrusion 32, spread of the separation, and the like. The bump is provided so as to extend outwardly from the surface of the protrusion 32. Two or more bumps smaller than the protrusion 32 may be provided. Also, the bump may be formed on a side face of the protrusion 32 so as to extend in the circumferential direction and/or the growth direction of the protrusion 32. Also, when the protrusion 32 has a flat top face at the end, the top face may have one or more bumps smaller than the protrusion 32. Further, the top face may have one or more bumps that extend in one direction.

The negative electrode current collector 31 can be produced, for example, by utilizing a technique for roughening a metal sheet. Specifically, it can be produced, for example, by a method using a roller having depressions in the surface (hereinafter referred to as “roller process”), a photoresist method, and the like. Among these methods, the roller process is preferable in consideration of the bonding strength between the negative electrode current collector 31 and the protrusions 32, and the like. As the metal sheet, for example, a metal foil or a metal plate can be used. The material of the metal sheet is, for example, a metal material such as stainless steel, titanium, nickel, copper, or a copper alloy.

According to the roller process, a metal sheet is mechanically pressed, using a roller having depressions in the surface (hereinafter referred to as a “protrusion-forming roller”). The depressions in the surface of the protrusion-forming roller are formed so as to correspond to the dimensions and arrangement of the protrusions 32. Also, the shape of the internal spaces of the depressions corresponds to the shape of the protrusions 32. When the metal sheet is pressed with the protrusion-forming roller, plastic deformation of the metal occurs mainly in the outermost layer of at least one surface of the metal sheet, so that the protrusions 32 are formed. In this way, the negative electrode current collector 31 can be produced.

At this time, by pressing two protrusion-forming rollers against each other such that their axes are parallel and pressing a metal sheet while passing it therebetween, the negative electrode current collector 31 with the protrusions 32 on both surfaces in the thickness direction can be obtained. Also, by pressing a protrusion-forming roller and a roller with a flat surface against each other such that their axes are parallel and pressing a metal sheet while passing it therebetween, the negative electrode current collector 31 with the protrusions 32 on one surface in the thickness direction can be obtained. The pressure for pressing the rollers against each other is selected as appropriate, depending on the material and thickness of the metal sheet, the shape and dimensions of the protrusions 32, the set value of the thickness of the negative electrode current collector 31 obtained by the pressing, etc.

The protrusion-forming roller can be produced, for example, by forming depressions at predetermined positions of the surface of a ceramic roller. The ceramic roller includes, for example, a core roller and a thermal spray layer. The core roller can be a roller made of, for example, iron or stainless steel. The thermal spray layer is formed by spraying a ceramic material, such as chromium oxide, uniformly onto the surface of the core roller. Depressions are then formed in the thermal spray layer. The depressions can be formed by using a common laser used to work ceramics materials and the like.

A protrusion-forming roller in another embodiment comprises a core roller, a base layer, and a thermal spray layer. The core roller is the same as the core roller of the ceramic roller. The base layer is a resin layer formed on the surface of the core roller, and depressions are formed in the surface of the base layer. The base layer is preferably composed of a synthetic resin with a high mechanical strength, and examples of such synthetic resins include thermosetting resins such as unsaturated polyester, thermo-setting polyimides, epoxy resins, and fluorocarbon resin, and thermoplastic resins such as polyamides, polyether ketone, and polyether ether ketone.

The depressions can be formed in the base layer, for example, by forming a resin sheet with depressions in one face thereof, wrapping the other face of the resin sheet (i.e., the face opposite to the face with the depressions) around the surface of the core roller, and bonding it. The thermal spray layer is formed by spraying a ceramic material, such as chromium oxide, onto the surface of the base layer with the depressions. Thus, the depressions formed in the base layer are preferably larger than the designed dimensions of the protrusions 32 by the thickness of the thermal spray layer.

A protrusion-forming roller in another embodiment comprises a core roller and a cemented carbide layer. The core roller is the same as the core roller of the ceramic roller. The cemented carbide layer is formed on the surface of the core roller, and includes a cemented carbide such as tungsten carbide. The cemented carbide layer can be formed by fitting a cemented carbide cylinder to a core roller by shrink fit or expansion fit. As used herein, “shrink fit” of a cemented carbide layer refers to a process of heating a cemented carbide cylinder to expand it and fitting the expanded cemented carbide cylinder around a core roller. Also, “expansion fit” of a cemented carbide layer as used herein refers to a process of cooling a core roller to shrink it and inserting the shrunk core roller into a cemented carbide cylinder. Depressions are formed in the surface of the cemented carbide layer, for example, by laser machining.

A protrusion-forming roller in another embodiment comprises a hard iron roller with depressions formed in the surface by, for example, laser machining. Hard iron rollers are used, for example, to roll and produce metal foil. Examples of hard iron rollers include a roller made of high speed steel and a roller made of forged steel. High speed steel is an iron-based material whose hardness is heightened by adding metals such as molybdenum, tungsten, and vanadium and applying a heat treatment. Forged steel is an iron-based material produced by heating a steel ingot, which is prepared by pouring molten steel into a mold, or a steel billet prepared from such a steel ingot, forging it with a press and a hammer or rolling and forging it, and heat-treating it.

According to the photoresist method, the negative electrode current collector 31 can be produced by forming a resist pattern on the surface of a metal sheet and applying metal plating.

Also, in the case of forming bumps on the surfaces of the protrusions 32, first, projections for forming the protrusions, which are larger than the designed dimensions of the protrusions 32, are formed by the photoresist method. These projections are then etched to form the protrusions 32 with bumps on the surfaces. Also, the protrusions 32 with bumps on the surfaces can also be produced by plating the surfaces of the protrusions 32.

The negative electrode active material layer 33 includes, for example, the columns 34 which extend outwardly from the surfaces of the protrusions 32, as illustrated in FIG. 9 and FIG. 10. The columns 34 extend perpendicularly to the surface 31a of the negative electrode current collector 31, or extend slantwise relative to the direction perpendicular to the surface 31a. Also, since the columns 34 are spaced apart from one another with gaps between the adjacent columns 34, the stress caused by expansion and contraction due to charge and discharge is reduced. As a result, the negative electrode active material layer 33 is unlikely to separate from the protrusions 32, and the negative electrode current collector 31 and hence the negative electrode 30 are also unlikely to become deformed.

Each of the columns 34 is preferably provided in the form of a laminate of two or more columnar pieces. In this embodiment, each of the columns 34 is provided in the form of a laminate of eight columnar pieces 34a, 34b, 34c, 34d, 34e, 34f, 34g, and 34h, as illustrated in FIG. 10. More specifically, the column 34 is formed as follows. First, the columnar piece 34a is formed so as to cover the top face of the protrusion 32 and an adjacent part of the side face. The columnar piece 34b is then formed so as to cover the remaining part of the side face of the protrusion 32 and a part of the top face of the columnar piece 34a.

That is, in FIG. 10, the columnar piece 34a is formed on one side of the protrusion 32 so as to include the top face, and the columnar piece 34b is formed on the other side of the protrusion 32 while partially overlapping with the columnar piece 34a. Further, the columnar piece 34c is formed so as to cover the remaining part of the top face of the columnar piece 34a and a part of the top face of the columnar piece 34b. That is, the columnar piece 34c is formed so that it mainly contacts the columnar piece 34a. Further, the columnar piece 34d is formed so that it mainly contacts the columnar piece 34b. Likewise, the columnar pieces 34e, 34f, 34g, and 34h are alternately laminated to form the column 34.

The columns 34 can be produced using, for example, an electron beam deposition device 40 illustrated in FIG. 11. In FIG. 11, the respective components in the deposition device 40 are also illustrated by the solid line. The deposition device 40 includes a chamber 41, a first pipe 42, a support table 43, a nozzle 44, a target 45, an electron beam generator (not shown), a power source 46, and a second pipe (not shown).

The chamber 41 is a pressure-resistant container, and contains the first pipe 42, the support table 43, the nozzle 44, and the target 45. One end of the first pipe 42 is connected to the nozzle 44, and the other end thereof extends outside the chamber 41 and is connected via a massflow controller (not shown) to a raw material gas cylinder or raw material gas production device (not shown). Examples of raw material gases include oxygen and nitrogen. A raw material gas is supplied to the nozzle 44 through the first pipe 42.

The support table 43 is shaped like a plate and is rotatably supported. The negative electrode current collector 31 is to be fixed to one face of the support table 43 in the thickness direction. The support table 43 is rotated between the position shown by the solid line and the position shown by the dot-dashed line in FIG. 11. When the support table 43 is at the position shown by the solid line, the face of the support table 43 to which the negative electrode current collector 31 is to be fixed faces the nozzle 44 positioned vertically below the support table 43, and the angle formed between the support table 43 and a horizontal straight line is α°. When the support table 43 is at the position shown by the dot-dashed line, the face of the support table 43 to which the negative electrode current collector 31 is to be fixed faces the nozzle 44 positioned vertically below the support table 43, and the angle formed between the support table 43 and a horizontal straight line is (180−α)° . The angle α° can be selected as appropriate, depending on the designed dimensions of the columns 34 and the like.

The nozzle 44 is disposed vertically between the support table 43 and the target 45 and connected to one end of the first pipe 42. Through the nozzle 44, a mixture of the vapor of an alloyable active material rising vertically from the target 45 and the raw material gas supplied from the first pipe 42 is fed to the surface of the negative electrode current collector 31 fixed to the surface of the support table 43. The target 45 contains the alloyable active material or the raw material thereof. The alloyable active material or the raw material thereof contained in the target 45 is irradiated with an electron beam by the electron beam generator, so that it is heated and becomes vapor.

The power source 46, which is disposed outside the chamber 41, is electrically connected to the electron beam generator to apply a voltage necessary for generating an electron beam to the electron beam generator. The second pipe is used to fill the chamber 41 with a gas. An electron beam deposition device with the same structure as that of the deposition device 40 is commercially available, for example, from ULVAC, Inc.

The electron beam deposition device 40 is operated as follows. First, the negative electrode current collector 31 is fixed to the support table 43, and oxygen gas is introduced into the chamber 41. In this state, the alloyable active material or the raw material thereof in the target 45 is irradiated with an electron beam, so that it is heated and becomes vapor. In this embodiment, silicon is used as the alloyable active material. The vapor rises vertically, and when it passes through the nozzle 44, it is mixed with the raw material gas. The vapor further rises and is fed to the surface of the negative electrode current collector 31 fixed to the support table 43, so that a layer containing silicon and oxygen is formed on the surfaces of the protrusions 32 (not shown).

At this time, by placing the support table 43 at the position shown by the solid line, the columnar piece 34a illustrated in FIG. 10 is formed. Next, by rotating the support table 43 to the position shown by the dot-dashed line, the columnar piece 34b illustrated in FIG. 10 is formed. In this way, by alternately rotating the support table 43, the columns 34 each of which is a laminate of the eight columnar pieces 34a, 34b, 34c, 34d, 34e, 34f, 34g, and 34h illustrated in FIG. 10 are formed on the surfaces of the protrusions 34 simultaneously, so that the negative electrode active material layer 33 is formed.

When the alloyable active material is, for example, a silicon oxide represented by SiOₐ where 0.05<a<1.95, the columns 34 may be formed so that there is an oxygen concentration gradient in the thickness direction of the columns 34. Specifically, they are formed so that the oxygen content is high near the negative electrode current collector 31 and that the oxygen content lowers as the distance from the negative electrode current collector 31 increases. In this case, the adhesion between the protrusions 32 and the column 34 can be further enhanced.

It should be noted that when no raw material gas is supplied from the nozzle 44, the columns 34 formed are composed mainly of silicon or tin simple substance. Also, if the negative electrode current collector 22a is used instead of the negative electrode current collector 31 and the support table 43 is secured horizontally without being rotated, the negative electrode active material layer 22b can be formed.

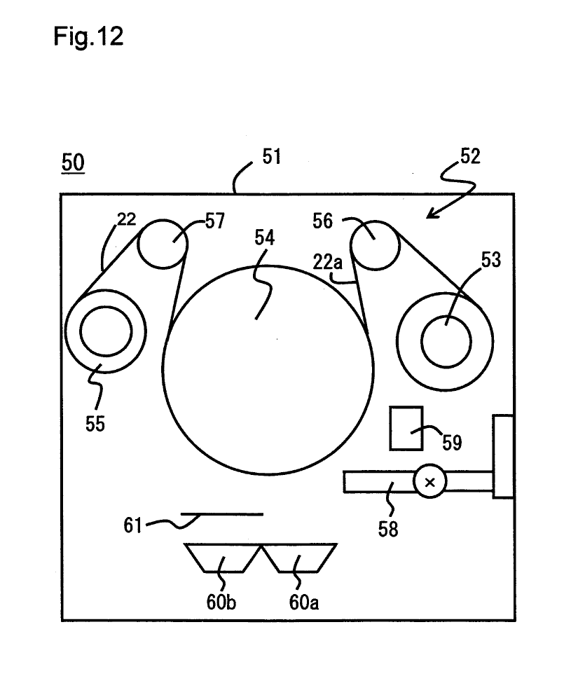

FIG. 12 is a side view schematically showing the configuration of an electron beam deposition device 50 in another embodiment. The deposition device 50 includes a chamber 51, transport means 52, gas supply means 58, plasma-generating means 59, silicon targets 60a and 60b, a shield plate 61, and electron-beam generating means (not shown). The chamber 51 is a pressure-resistant container having an inner space whose pressure can be reduced. It contains the transport means 52, the gas supply means 58, the plasma-generating means 59, the silicon targets 60a and 60b, the shield plate 61, and the electron-beam generating means.

The transport means 52 includes a supply roller 53, a can 54, a take-up roller 55, and transport rollers 56 and 57. Each of the supply roller 53, the can 54, and the transport rollers 56 and 57 is rotatably supported on the axis. The long negative electrode current collector 22a is wound around the supply roller 53. The can 54 is larger in diameter than the other rollers, and contains cooling means (not shown) therein. When the negative electrode current collector 22a is transported on the surface of the can 54, the negative electrode current collector 22a is also cooled. Thus, the vapor of the alloyable active material is cooled and deposited to form the negative electrode active material layer 22b.

The take-up roller 55 is rotatably supported on the axis by driving means (not shown). One end of the negative electrode current collector 22a is fixed to the take-up roller 55. Due to the rotation of the take-up roller 55, the negative electrode current collector 22a is transported from the supply roller 53 through the transport roller 56, the can 54, and the transport roller 57. The negative electrode 22 with the negative electrode active material layer 22b formed on the surface is rewound around the take-up roller 55.

In the case of forming a thin film composed mainly of an oxide, nitride, etc. of silicon or tin, a raw material gas such as oxygen or nitrogen is supplied into the chamber 51. The plasma-generating means 59 makes the raw material gas supplied from the gas supply means 58 into plasmatic condition. The silicon targets 60a and 60b are used to form a thin film including silicon. The shield plate 61 is horizontally movable vertically below the can 54 and vertically above the silicon targets 60a and 60b. The position of the shield plate 61 in the horizontal direction is suitably adjusted depending on the condition of the negative electrode active material layer 22b that is being formed on the surface of the negative electrode current collector 22a. The electron-beam generating means irradiates the silicon targets 60a and 60b with an electron beam to heat it and produce silicon vapor.

The deposition device 50 can produce a thin-film negative electrode active material layer made of an alloyable active material. In this case, the pressure inside the chamber 51, the speed with which the negative electrode current collector 22a is rewound by the take-up roller 55, whether or not a raw material gas is supplied by the gas supply means 58, the kind of the targets 60a and 60b (raw material for an alloyable active material), the acceleration voltage of the electron beam, the emission of the electron beam, etc. are selected as appropriate.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

### INDUSTRIAL APPLICABILITY

The battery pack of the invention can be used in the same applications as those of conventional non-aqueous electrolyte secondary batteries. In particular, it is useful as the power source for portable electronic devices such as personal computers, cellular phones, mobile devices, personal digital assistants (PDA), portable game machines, video cameras, and the like. It is also expected to be used as the secondary battery for assisting the electric motor in hybrid electric vehicles, fuel cell cars, etc., the power source for power tools, vacuum cleaners, robots, etc., and the power source for plug-in HEVs, etc.

1. A battery pack comprising:
a non-aqueous electrolyte secondary battery comprising an electrode assembly, a lithium-ion conductive non-aqueous electrolyte, and a battery case for housing the electrode assembly and the non-aqueous electrolyte, the electrode assembly comprising a positive electrode including a positive electrode active material capable of absorbing and desorbing lithium, a negative electrode including an alloyable active material, and an insulating layer interposed between the positive electrode and the negative electrode;
thickness detection means for detecting the thickness of the electrode assembly;
cycle number detection means for detecting the number of charge and discharge cycles of the non-aqueous electrolyte secondary battery; and
determination means for determining the replacement time of the non-aqueous electrolyte secondary battery or the presence or absence of cycle deterioration of the non-aqueous electrolyte secondary battery according to a detection result by the thickness detection means and a detection result by the cycle number detection means.

2. The battery pack in accordance with claim 1, wherein the determination means determines whether or not the thickness of the electrode assembly detected by the thickness detection means is smallest according to the detection result by the thickness detection means and the detection result by the cycle number detection means, and calculates the replacement time of the non-aqueous electrolyte secondary battery according to a determination result that the thickness of the electrode assembly is smallest.

3. The battery pack in accordance with claim 2, wherein the determination means stores a set value of the smallest thickness of the electrode assembly, and the determination means determines that the thickness of the electrode assembly is smallest when the thickness of the electrode assembly detected by the thickness detection means is in the range from the set value×0.9 to the set value×1.1.

4. The battery pack in accordance with claim 1, wherein the thickness detection means detects the thickness of the electrode assembly by measuring the inner pressure of the electrode assembly as thickness information of the electrode assembly.

5. The battery pack in accordance with claim 1, wherein the determination means determines the presence or absence of cycle deterioration of the non-aqueous electrolyte secondary battery by calculating the correlation between the thickness of the electrode assembly and the number of charge and discharge cycles according to the detection result by the thickness detection means and the detection result by the cycle number detection means, and detecting a change in the correlation.

6. The battery pack in accordance with claim 5, wherein the change in the correlation is a change in the thickness of the electrode assembly with the number of charge and discharge cycles.

7. The battery pack in accordance with claim 6, wherein the correlation is a proportional relationship, and the change in the correlation is a change in a proportionality constant in the proportional relationship.

8. The battery pack in accordance with claim 7, wherein the change in the proportionality constant is such a change that the proportionality constant becomes greater than a predetermined value.

9. The battery pack in accordance with claim 5, further comprising a housing that contains the non-aqueous electrolyte secondary battery, the thickness detection means, the cycle number detection means, and the determination means,
wherein the non-aqueous electrolyte secondary battery is fixed to at least a part of an inner face of the housing, and
the thickness detection means includes a pressure sensor for detecting the inner pressure of the electrode assembly, receives a detection result of the inner pressure of the electrode assembly by the pressure sensor as thickness information of the electrode assembly, and calculates the thickness of the electrode assembly from the detection result.

10. The battery pack in accordance with claim 1, further comprising indication means for indicating a determination result by displaying it or by sound according to a determination result of replacement time or a determination result that cycle deterioration has occurred.

11. The battery pack in accordance with claim 1, further comprising charge and discharge control means for stopping the charge and discharge of the non-aqueous electrolyte secondary battery according to a determination result of replacement time or a determination result that cycle deterioration has occurred.

12. The battery pack in accordance with claim 1, wherein the electrode assembly is a laminated electrode assembly or flat electrode assembly.

13. The battery pack in accordance with claim 1, wherein the alloyable active material is at least one selected from silicon-based active materials and tin-based active materials.
